(19) United States
(12) Patent Application Publication
(10) Pub. No.: US 2022/0306849 A1
(43) Pub. Date: Sep. 29, 2022

(54) Thermoplastic Vulcanizate Compositions and Processes for the Production Thereof

(71) Applicant: Celanese International Corporation, Irving, TX (US)

(72) Inventors: Antonios K. Doufas, Houston, TX (US); Krishnan Anantha Narayana Iyer, Pearland, TX (US); Zerong Lin, Porter, TX (US); Ranadip Ganguly, Houston, TX (US)

(21) Appl. No.: 17/771,135

(22) PCT Filed: Oct. 13, 2020
(86) PCT No.: PCT/US2020/055325

§ 371 Date: Apr. 22, 2022

Related U.S. Application Data
(60) Provisional application No. 62/924,395, filed on Oct. 22, 2019.

(51) Int. Cl. C08L 23/12; C08F 210/18; C08K 3/22; C08K 5/098

(52) U.S. Cl. CPC C08L 23/12; C08F 210/18; C08K 3/22; C08K 5/098; C08L 2205/025; C08L 2205/035; C08L 2312/00; C08L 2205/06; C08L 2207/322; C08F 2810/20; C08K 2003/2296

(57) ABSTRACT

The present disclosure relates to a thermoplastic vulcanizate including a polypropylene and a copolymer. The copolymer may have an ethylene content, a propylene content, and an a, α,ω-diene content. The thermoplastic vulcanizate has a shore hardness of about 20 Shore A or greater. Alternatively, a thermoplastic vulcanizate may include a polypropylene and an elastomeric polymer and have a shore hardness of about 50 MPa or greater, a tensile strength at yield of about 18 MPa or greater, and an oil swell of about 15% weight gain or less. Additionally, the present disclosure relates to processes for producing thermoplastic vulcanizates. A process may include introducing a catalyst and propylene to a first reactor to form a first polymer, and introducing the first polymer, ethylene, at least one α,ω-diene, and optionally additional propylene to a second reactor to form an impact copolymer. The process may further include crosslinking the impact copolymer.

### CROSS-REFERENCE TO RELATED APPLICATIONS

This application claims the priority benefit of U.S. Ser. No. 62/924,395, filed Oct. 22, 2019, which is incorporated herein by reference.

### FIELD

The present disclosure relates to thermoplastic vulcanizate compositions having improved physical properties. The present disclosure also relates to simplified processes for production of thermoplastic vulcanizate compositions.

### BACKGROUND

Thermoplastic vulcanizates (TPVs) and Impact copolymers (ICPs) are heterogeneous polymer blends and are commonly used in industry and consumer goods. For example, TPVs and ICPs may be used as auto parts, such as dashboards and bumpers, air ducts, weatherseals, fluid seals, and other under the hood applications; as gears and cogs, wheels and drive belts for machines; as cases and insulators for electronic devices; as fabric for carpets, clothes and bedding and as fillers for pillows and mattresses; and as expansion joints for construction. TPVs and ICPs are also widely used in consumer goods, being readily processed, capable of coloration as with other plastics, and providing elastic properties that can endow substrate materials, or portions thereof, for instance harder plastics or metals, in multi-component laminates, with a “soft touch” or rebound properties like rubber.

Typically, ICPs are not converted to TPVs by crosslinking because the molecular weight of the secondary copolymer may be limited by hydrogen carry-over into the copolymer polymerization.

TPVs, typically include finely dispersed cross-linked elastomer particles forming a disperse phase in a continuous thermoplastic phase. TPVs have the benefit of the elastomeric properties provided by the elastomer phase, with the processability of thermoplastics. The heterogeneous polymer blends have multiphase morphology where a thermoplastic such as isotactic polypropylene forms a continuous matrix phase and the elastomeric component, often derived from an ethylene containing copolymer, forms a dispersed component. The polypropylene matrix imparts tensile strength and chemical resistance to the TPV, while the ethylene copolymer imparts flexibility and impact resistance.

The heterogeneity of TPVs means that there is a balance between the properties imparted by the matrix phase and the elastomeric component. In many cases, improving one will have a deleterious effect on another. Therefore, there is a continuous need to develop thermoplastic vulcanizate compositions of enhanced balance of mechanical properties, more specifically an improved balance of hardness, tensile strength, elastic recovery, and oil swell.

The production of TPVs typically includes separate production of the matrix and elastomeric component. The elastomeric component is typically an ethylene/propylene/diene copolymer (EPDM). The EPDM is placed in bales and is granulated before it can be mixed with the matrix polymer in an extruder. The multi-step process is not cost or energy efficient because storage and granulation of the EPDM is costly and energy intensive. The formation of impact copolymers is often accomplished as a reactor blend, avoiding the cost and energy requirements related to separate production and subsequent blending. However, ICPs are not typically converted to TPVs because the production of the secondary copolymer in the reactor with the matrix may produce an elastomeric component with low molecular weight because of the hydrogen carry-over from one polymerization to the next within the reactor. Additionally, reactor blends for TPVs have been sought as an alternative to physical blending since reactor blends offer the possibility of improved mechanical properties through more intimate mixing between the hard and soft phases, through the generation of hard/soft cross products, as well as lower production costs. There is a need for simplification of the processes for forming TPVs, for example, by (1) reducing the number of ingredients in the formulation to improve compounding efficiency, (2) reducing or eliminating the need to granulate rubber bales before being fed to an extruder, and/or (3) developing processes that would allow for reactor blends of matrix and elastomeric components.

References for citing in an information disclosure statement pursuant to (37 C.F.R. 1.97(h)) include: U.S. Pat. Nos. 4,622,193; 4,822,545; 4,970,118; 7,915,345; 8,022,142; 8,101,685; 8,106,127; 8,481,646; 9,068,034; and application No. WO 2012112259A3.

### SUMMARY

The present disclosure relates to a thermoplastic vulcanizate including a polypropylene and a crosslinked copolymer. The copolymer may have an ethylene content, a propylene content, and an α,ω-diene content. The thermoplastic vulcanizate has a shore hardness of about 50 MPa or greater. The present disclosure also relates to a thermoplastic vulcanizate including a polypropylene and an elastomeric polymer. The thermoplastic vulcanizate has a shore hardness of about 50 MPa or greater, a tensile strength at yield of about 18 MPa or greater, and an oil swell of about 15% weight gain or less.

Additionally, the present disclosure relates to processes for producing thermoplastic vulcanizates. A process may include introducing a catalyst and propylene to a first reactor to form a first polymer, and introducing the first polymer, ethylene, at least one α,ω-diene, and optionally additional propylene to a second reactor to form an impact copolymer. The process may further include crosslinking the impact copolymer. The present disclosure also relates to articles of manufacture including the thermoplastic vulcanizates described or formed by processes described.

### DETAILED DESCRIPTION

It has been discovered that introducing one or more α,ω-dienes during production of the elastomeric component of an impact copolymer produces an ICP with improved intrinsic viscosity, molecular weight distribution, and viscosity ratio. The rubbery secondary polymer has increased molecular weight and the ICP may be crosslinked to form a TPV with improved balance of mechanical properties, such as hardness, tensile strength, and elastic recovery. Additionally, the increase in the molecular weight of the rubbery secondary polymer does not produce gels which would otherwise be detrimental to the use of TPVs in molded parts. Furthermore, the addition of α,ω-dienes may improve TPVs by including vinyl termination(s) that may be useful for crosslinking after polymerization of the reactor blend. The introduction of one or more α,ω-dienes to processes used for production of ICPs and then subsequent crosslinking, is more cost and energy efficient than current TPV processes, as there is no need to bale and then granulate a rubber for co-extrusion.

Propylene based ICP's are typically an intimate mixture of a continuous phase of a crystalline polypropylene polymer and a dispersed rubbery phase of a secondary polymer, e.g., an ethylene copolymer. While ICP products have been produced by melt compounding the individual polymer components, multi-reactor technology makes it possible to produce ICPs directly. Direct production of ICPs may be accomplished by polymerizing propylene in a first reactor and transferring the polypropylene polymer from the first reactor into a second reactor where the secondary copolymer is produced in the presence of the polypropylene polymer. TPVs are also blends of thermoplastic and elastomer, like ICPs, except that the dispersed elastomeric component is crosslinked or vulcanized. The crosslinking may take place in a reactive extruder during compounding, in a process known as dynamic vulcanization, a process that involves selectively crosslinking (otherwise referred to alternatively as curing or vulcanizing) the elastomer component during its melt mixing with the molten thermoplastic under intensive shear and mixing conditions within a blend of at least one non-vulcanizing thermoplastic polymer component while at or above the melting point of that thermoplastic. Cross-linking of the elastomeric phase typically allows dispersion of higher amounts of rubber in the polymer matrix, stabilizes the obtained morphology by preventing coalescence of rubber particles, and enhances mechanical properties of the blend.

### Definitions

The term “polymer” includes, but is not limited to, homopolymers, copolymers, terpolymers, etc., and alloys and blends thereof. The term “polymer” also includes impact, block, graft, random, and alternating to copolymers. The term “polymer” shall further include all possible geometrical configurations unless otherwise specifically stated. Such configurations may include isotactic, syndiotactic and random symmetries.

The term “copolymer” is meant to include polymers having two or more monomers, optionally, with other monomers, and may refer to interpolymers, terpolymers, etc.

The term “blend” refers to a mixture of two or more polymers.

The term “monomer”, can refer to the monomer used to form a polymer, including the unreacted chemical compound in the form prior to polymerization, and the monomer after it has been incorporated into the polymer. Different monomers are discussed, including propylene monomers, ethylene monomers, and diene monomers.

The term “comonomer” can refer to a second monomer used to form a polymer, including the unreacted chemical compound in the form prior to polymerization, and the comonomer after it has been incorporated into the polymer. Different comonomers are discussed, including ethylene monomers, and diene monomers, such as α,ω-dienes.

The term “polypropylene” and “propylene polymer” are used interchangeably and include homopolymers and copolymers of propylene or mixtures thereof.

The term “reactor blend” means a dispersed and mechanically inseparable blend of two or more polymers produced in situ. For example, a reactor blend polymer may be the result of a sequential (or series) polymerization process where a first polymer component is produced in a first reactor and a second polymer component is produced in a second reactor in the presence of the first polymer component. Alternatively, a reactor blend polymer may be the result of a parallel polymerization process where the polymerization effluent containing the polymer components made in separate parallel reactors are solution blended to form the final polymer product. Reactor blends may be produced in a single reactor, a series of reactors, or parallel reactors and are reactor grade blends. Reactor blends may be produced by any suitable polymerization method, including batch, semi-continuous, or continuous systems. Excluded from the definition of “reactor blend” polymers are blends of two or more polymers in which the polymers are blended ex situ, such as by physically or mechanically blending in a mixer, extruder, or other similar device.

The term “intrinsic viscosity” or “IV” means the viscosity of a solution of polymer in a given solvent at a given temperature, when the polymer composition is at infinite dilution and is calculated according to the ASTM D1601 standard. Typically, and in accordance with ASTM D1601 the IV measurement utilizes a standard capillary viscosity measuring device, in which the viscosity of a series of concentrations of the polymer in the solvent at a given temperature are determined. For component B, decalin is a suitable solvent and a typical temperature is 135° C. From the values of the viscosity of solutions of varying concentrations, the viscosity at infinite dilution is determined by extrapolation.

The term “catalyst system” means the combination of one or more catalysts with one or more activators and, optionally, one or more support compositions.

An “activator” is a compound or component, or combination of compounds or components, capable of enhancing the ability of one or more catalysts to polymerize monomers to polymers.

The term “impact copolymer” (“ICP”) means those blends including at least two components, the blend being substantially thermoplastic and having a high impact resistance, for example a flexural modulus measurable by ISO 178 method of about 250 MPa or greater, such as about 500 MPa or greater.

The term “thermoplastic vulcanizate composition” (also referred to as “thermoplastic vulcanizate” or “TPV”) is broadly defined as a material that includes a dispersed, at least partially vulcanized, rubber component; a thermoplastic component; and an additive oil. A TPV material may further include other ingredients, other additives, or both.

The term “vulcanizate” means a composition that includes some component (e.g., rubber component) that has been vulcanized. The term “vulcanized” refers in general to the state of a composition after all or a portion of the composition (e.g., crosslinkable rubber) has been subjected to some degree or amount of vulcanization. Accordingly, the term encompasses both partial and total vulcanization. An example type of vulcanization is “dynamic vulcanization,” discussed below, which also produces a “vulcanizate.” Also, in at least one embodiment, the term vulcanized refers to more than insubstantial vulcanization, e.g., curing (crosslinking) that results in a measurable change in pertinent properties, e.g., a change in the melt flow rate (MFR) of the composition by 10% or more (according to an ASTM-1238 procedure). In at least that context, the term vulcanization encompasses any suitable form of curing (crosslinking), both thermal and chemical that can be utilized in dynamic vulcanization.

The term “dynamic vulcanization” means vulcanization or curing of a curable rubber blended with a thermoplastic resin under conditions of shear at temperatures sufficient to plasticize the mixture. In at least one embodiment, the rubber is simultaneously crosslinked and dispersed as micro-sized particles within the thermoplastic component. Depending on the degree of cure, the rubber to thermoplastic component ratio, compatibility of rubber and thermoplastic component, the kneader/mixer/extruder type and the intensity of mixing (shear rate/shear stress), other morphologies, such as co-continuous rubber phases in the plastic matrix, are possible.

The term “partially vulcanized” rubber means more than 5 weight percent (wt %) of the crosslinkable rubber is extractable in boiling xylene, subsequent to vulcanization (such as dynamic vulcanization), e.g., crosslinking of the rubber phase of the thermoplastic vulcanizate. For example, less than 10 wt %, or less than 20 wt %, or less than 30 wt %, or less than 50 wt % of the crosslinkable rubber may be extractable from the specimen of the thermoplastic vulcanizate in boiling xylene. The percentage of extractable rubber can be determined by the technique set forth in U.S. Pat. No. 4,311,628, and the portions of that patent referring to that technique are incorporated herein by reference.

The term “fully vulcanized” (or fully cured or fully crosslinked) rubber means 5 weight percent (wt %) or less of the crosslinkable rubber is extractable in boiling xylene or cyclohexane, subsequent to vulcanization (such as dynamic vulcanization), e.g., crosslinking of the rubber phase of the thermoplastic vulcanizate. For example, less than 4 wt % or less, or 3 wt % or less, or 2 wt % or less, or 1 wt % or less of the crosslinkable rubber is extractable in boiling xylene or cyclohexane.

A “composition” includes components of the composition and/or reaction products of two or more components of the composition.

“Pre-cure” refers to before the addition of a curative to the extrusion reactor. For example, pre-cure oil refers to the oil added to the extrusion reactor before the addition of a curative to the extrusion reactor. This pre-cure oil may also be referred to as a first amount of oil.

“Post-cure” refers to after the addition of a curative to the extrusion reactor.

### Thermoplastic Vulcanizate Compositions

A TPV is a blend of at least two components and may include, for example, a crystalline polymer such as polypropylene (“component A”) and an elastomeric/rubber-like component (“component B”). An ICP may include from about 40 wt % to about 95 wt % component A and from about 5 wt % to about 60 wt % component B, or from about 50 wt % to about 90 wt % component A and from about 10 wt % to about 50 wt % component B, or from about 60 wt % to about 90 wt % component A and from about 10 wt % to about 40 wt % component B, or from about 70 wt % to about 85 wt % component A and from about 15 wt % to about 30 wt % component B. In some embodiments, the TPV may consist essentially of components A and B.

The overall comonomer (e.g., ethylene and α,ω-diene) content of the TPV may be from about 3 wt % to about 40 wt %, or from about 5 wt % to about 25 wt %, or from about 6 wt % to about 20 wt %, or from about 7 wt % to about 15 wt %.

The TPVs may, in some embodiments, be reactor blends, meaning that components A and B are not physically or mechanically blended together after polymerization but are interpolymerized in at least one reactor, often in two or more reactors in series. The TPV as obtained from the reactor or reactors, however, may be blended with various other components including other polymers or additives. In other embodiments, however, a TPV may be formed by producing components A and B in separate reactors and physically blending the components once they have exited their respective reactors.

In some embodiments, a TPV may be described as “heterophasic.” The term “heterophasic” means that the polymers have two or more phases. Typically, heterophasic TPVs include a matrix component in one phase and an elastomeric component phase, for example rubber phase, dispersed within the matrix. In some embodiments, the TPVs include a matrix phase including a propylene homopolymer (component A) and a dispersed phase including a propylene-ethylene-α,ω-diene copolymer (component B). The copolymer component (component B) has rubbery characteristics and provides impact resistance, while the matrix component (component A) provides overall stiffness.

### Production of ICPs

An ICP can be prepared by any suitable polymerization technique. For example, an ICP may be produced using a two-stage gas phase process using Ziegler-Natta catalysis, an example of which is described in U.S. Pat. No. 4,379,759, incorporated by reference. ICPs may also be produced in reactors operated in series. In such series operations, the stage 1 includes polymerization of component A and may include a liquid slurry or solution polymerization process, and the stage 2 includes polymerization of component B and may be carried out in the gas phase. In some embodiments, hydrogen may be added to stage 1, stage 2, or both to control molecular weight, intrinsic viscosity, and/or melt flow rate.

A catalyst system is introduced at the beginning of the polymerization of propylene and may be transferred with the resulting component A to the copolymerization reactor where the catalyst system may also serve to catalyze the gas phase copolymerization of component B to produce an ICP. Additional catalyst composition may be added in stage 1 and/or stage 2 at any suitable point in the reactor(s).

Component A, sometimes referred to as the ICP matrix, including propylene homopolymer may be prepared using at least one reactor and may also be prepared using a plurality of parallel reactors or reactors in series. The propylene homopolymer is typically made in a unimodal molecular weight fashion, for example, each reactor of stage 1 produces polymer of the same melt flow rate (MFR)/molecular weight (MW). Additionally, component A may include a bimodal or multi-modal propylene-based polymer.

Once formation of the propylene polymer (component A) is complete (stage 1), the resultant powder may be passed through a degassing stage before passing to one or more gas phase reactors (stage 2), where propylene is copolymerized with ethylene or an alpha-olefin co-monomer including, C4, C6, or C8 alpha olefins or combinations thereof, and at least one α,ω-diene in the presence of component A produced in stage 1 and the catalyst transferred therewith. Examples of gas phase reactors include, but are not limited to, a fluidized (horizontal or vertical) or stirred bed reactor or combinations thereof.

Additional discussion of the production and properties of component A in stage 1 and component B in stage 2 is included below.

### Production or TPVs

An ICP may undergo crosslinking to produce a TPV. An ICP may be combined with a curing agent to form a curing composition. The curing composition may be subject to conditions (temperature, irradiation, etc.) sufficient to cause crosslinking of compound B, the elastomeric component of the TPV. Curing compositions according to various embodiments may include a curing agent and/or coagents, and may further include a method of including a curing agent and/or coagent, as discussed in U.S. Pat. Nos. 8,653,170 and 8,653,197, incorporated by reference.

Suitable curing agents include one or more of silicon hydrides (which may affect hydrosilation cure), phenolic resins, peroxides, maleimides, free radical initiators, sulfur, zinc metal compounds, and the like. The named curatives are frequently used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂). The curing composition may be added in one or more locations, including the feed hopper of a melt mixing extruder. In some embodiments, the curing agent and additional coagents may be added to the TPV formulation together; in other embodiments, one or more coagents may be added to the TPV formulation at different times from one or more of the curing agents, as the TPV formulation is undergoing processing to form a TPV (discussed in greater detail below).

In some embodiments, peroxide curatives may be employed as disclosed in U.S. Pat. No. 5,656,693. Where the rubber is a butyl rubber, example cure systems are described in U.S. Pat. Nos. 5,013,793, 5,100,947, 5,021,500, 5,100,947, 4,978,714, and 4,810,752.

In some embodiments, the ICP is cured employing a hydrosilation curative. Useful hydrosilation curatives generally include silicon hydride compounds having at least two SiH groups. These compounds react with carbon-carbon double bonds of unsaturated polymers in the presence of a hydrosilation catalyst. Useful catalysts for hydrosilation include transition metals of Group VIII. These metals include palladium, rhodium, and platinum, as well as complexes of these metals. Silicon hydride compounds include methylhydrogen polysiloxanes, methylhydrogen dimethylsiloxane copolymers, alkyl methyl polysiloxanes, bis(dimethylsilyl)alkanes, bis(dimethylsilyl)benzene, and mixtures thereof. Additionally, example silicon-containing curatives and cure systems are disclosed in U.S. Pat. Nos. 5,936,028, 4,803,244, 5,672,660, and 7,951,871.

In some embodiments, the silane-containing compounds may be employed in an amount from about 0.5 parts by weight to about 5 parts by weight per 100 parts by weight of rubber (such as from about 1 parts by weight to about 4 parts by weight, such as from about 2 parts by weight to about 3 parts by weight). A complementary amount of catalyst may include from about 0.5 parts of metal to about 20 parts of metal per million parts by weight of the rubber (such as from about 1 parts of metal to about 5 parts of metal, such as from about 1 parts of metal to about 2 parts of metal).

Curing agents in some embodiments may include one or more phenolic resins. Suitable phenolic resins include those disclosed in U.S. Pat. Nos. 2,972,600; 3,287,440; 5,952,425; and 6,437,030 (each of which is incorporated by reference), and phenolic resins include those referred to as resole resins, and discussed in detail in U.S. Pat. No. 8,653,197 (previously incorporated by reference). In certain embodiments in which the curing composition includes phenolic resin, the curing composition also includes a cure accelerator, such as one or both of ZnO and SnCl₂.

In addition to the ZnO and SnCl₂, a curing composition may include other suitable co-agents, such as triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and similar.

Depending on the rubber employed, certain curatives may be employed. For example, where elastomeric copolymers containing units deriving from vinyl norbornene are employed, a peroxide curative may be used because the required quantity of peroxide will not have a deleterious impact on the engineering properties of the thermoplastic phase of the thermoplastic vulcanizate. In other embodiments, however, peroxide curatives are not employed because they may, at certain levels, degrade the thermoplastic components of the thermoplastic vulcanizate. Accordingly, some thermoplastic vulcanizates are cured in the absence of peroxide, or at least in the absence of an amount of peroxide that will have a deleterious impact on the engineering properties of the thermoplastic vulcanizate, which amount will be referred to as a substantial absence of peroxide.

An ICP may undergo crosslinking forming a TPV at elevated temperatures. In some embodiments, the crosslinking may take place at a temperature of about 150° C. or greater, such as about 160° C. or greater, about 170° C. or greater, about 180° C. or greater, about 190° C. or greater, about 200° C. or greater, about 210° C. or greater, about 220° C. or greater, about 230° C. or greater, about 240° C. or greater, or about 250° C. or greater.

In some embodiments, the elastomer can be crosslinked to produce a finely dispersed rubber domains in a thermoplastic polymer matrix. For example, in some embodiments, the elastomer is partially or fully (completely) crosslinked before an extrusion stage. It has been discovered that partially curing an elastomer before an extrusion stage, followed by post-extrusion crosslinking, improves the thermoset properties of a crosslinked elastomer-polymer blend while nonetheless maintaining sufficient thermoplastic properties of the blend for extrusion. The degree of crosslinking can be measured by determining the amount of elastomer that is extractable from the crosslinked elastomer product by using cyclohexane or boiling xylene as an extractant. A method for determining the degree of crosslinking is disclosed in U.S. Pat. No. 4,311,628, which is incorporated herein by reference. In some embodiments, the elastomer has a degree of crosslinking where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference. In these or other embodiments, the elastomer is crosslinked to an extent where greater than about 94 wt %, such as greater than about 95 wt %, such as greater than about 96 wt %, such as greater than about 97 wt % by weight of the elastomer is insoluble in cyclohexane at 23° C. Alternately, in some embodiments, the elastomer has a degree of cure such that the crosslink density is at least 4×10⁻⁵ moles per milliliter of elastomer, such as at least 7×10⁻⁵ moles per milliliter of elastomer, such as at least 10×10⁻¹ moles per milliliter of elastomer. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

A “partially vulcanized” rubber is one where more than 5 weight percent (wt %) of the crosslinkable rubber is extractable in boiling xylene, subsequent to vulcanization, e.g., crosslinking of the rubber phase of the TPV. For example, in a TPV including a partially vulcanized rubber at least 5 wt % and less than 20 wt %, or 30 wt %, or 50 wt % of the crosslinkable rubber can be extractable from the specimen of the TPV in boiling xylene.

Despite an elastomer being partially or fully cured in some embodiments, blends can be processed and reprocessed by plastic processing techniques such as extrusion, injection molding, blow molding, and compression molding.

In at least one embodiment, the elastomer is in the form of a thermoplastic vulcanizate including the elastomer and a thermoplastic polymer (such as a polypropylene). The elastomer can be in the form of finely-divided and well-dispersed particles of vulcanized or cured elastomer within a continuous thermoplastic phase or matrix. In some embodiments, a co-continuous morphology or a phase inversion can be achieved. In those embodiments where the cured elastomer is in the form of finely-divided and well-dispersed particles within the thermoplastic medium, the elastomer particles can have an average diameter that is about 50 μm or less (such as about 30 μm or less, such as about 10 μm or less, such as about 5 μm or less, such as about 1 μm or less). In some embodiments, at least about 50%, such as about 60%, such as about 75% of the particles have an average diameter of about 5 μm or less, such as about 2 μm or less, such as about 1 μm or less.

### TPV Properties

The thermoplastic vulcanizate can have an component B content from about 5 wt %, about 8 wt %, about 10 wt %, about 15 wt %, about 25 wt %, about 35 wt %, or about 45 wt % to about 55 wt %, about 65 wt %, about 75 wt %, or about 85 wt %, based on the total weight of the polymers in the TPV. For example, the TPV can have an component B content of about 5 wt % to about 80 wt %, about 5 wt % to about 60 wt %, about 5 wt % to about 50 wt %, about 5 wt % to about 40 wt %, about 6 wt % to about 35 wt %, about 7 wt % to about 30 wt %, or about 8 wt % to about 30 wt %, based on the total weight of the polymers in the TPV.

Component A and component B may include propylene. The impact copolymer can have a total propylene content of about 75 wt % or more, about 80 wt % or more, about 85 wt % or more, about 90 wt % or more, or about 95 wt % or more, based on the combined weight of propylene monomers in component A and component B.

The impact copolymer of the thermoplastic vulcanizate can have a total comonomer (in this instance referring to non-propylene monomers) content from about 1 wt %, about 5 wt %, about 9 wt %, or about 12 wt % to about 18 wt %, about 23 wt %, about 28 wt %, or about 35 wt %, based on the total weight of the impact copolymer of the TPV. For example, the impact copolymer can have a total comonomer content of about 1 wt % to about 35 wt %, about 2 wt % to about 30 wt %, about 3 wt % to about 25 wt %, or about 5 wt % to about 20 wt %, based on the total weight of the impact copolymer.

The uncured TPV may have a vinyl content, which is vinyl groups per 1000 Carbon atoms, as measured by H¹-NMR, from about 0.01 to about 5, such as from about 0.01 to about 2.5, from about 0.05 to about 1, or from about 0.1 to about 0.75.

The uncured TPV may have a C2% (wt % rubber as determined by low field solid state NMR) of about 5 wt % to about 40 wt %, such as about 8 wt % to about 30 wt % or about 15 wt % to about 25 wt %.

The uncured TPV may have a R % (wt % ethylene content in the rubber phase, determined by total wt % of ethylene measured by IR divided wt % or rubber (C2%)) of about 30 wt % to about 70 wt %, such as about 35 wt % to about 65 wt %, or about 40 wt % to about 60 wt %.

Melt Flow Rate (“MFR”) of the TPV may be from about 0.1 g/10 min to about 1000 g/10 min, such as from about 1 g/10 min to about 500 g/10 min, from about 1 g/10 min to about 50 g/10 min, from about 1 g/10 min to about 25 g/10 min, from about 1 g/10 min to about 20 g/10 min, or from about 1 g/10 min to 10 g/10 min. The MFR may be determined by ASTM-1238 measured at load of 2.16 kg at 230° C.

The impact copolymer of the thermoplastic vulcanizate can have an IV ratio prior to cross-linking from about 0.5, about 1.5, about 3, about 4, about 5, about 6, about 7, about 8, about 9, or about 10 to about 3, about 5, about 6, about 10, about 15, about 20, about 25, about 30, about 40, about 50, about 75 or about 100. For example, the impact copolymer component can have an IV ratio from about 0.5 to about 100, about 8 to about 75, about 10 to about 50, about 0.75 to about 6, or about 1 to about 7. The IV ratio is the ratio of the intrinsic viscosity (IV, ASTM D1601 at 135° C. in decalin) of component B to the intrinsic viscosity of component A (the matrix).

The thermoplastic vulcanizate can have a melting point (Tm, peak second melt) of about 100° C. or more, about 110° C. or more, about 120° C. or more, about 130° C. or more, about 140° C. or more, about 150° C. or more, about 160° C. or more, or about 165° C. or more. For example, the thermoplastic vulcanizate can have a melting point from about 100° C. to about 175° C., such as from about 105° C. to about 165° C., about 105° C. to about 145° C., or about 100° C. to about 155° C.

The thermoplastic vulcanizate can have a heat of fusion (Hf, DSC second heat) from about 20 J/g, about 30 J/g, about 40 J/g, or about 50 J/g to about 60 J/g, about 75 J/g, about 85 J/g, about 95 J/g, about 100 J/g or more. In at least one embodiment the TPV can have a heat of fusion of 60 J/g or more, 70 J/g or more, 80 J/g or more, 90 J/g or more, about 95 J/g or more, or about 100 J/g or more.

The thermoplastic vulcanizate can have glass transition temperature (Tg) of the ethylene copolymer component of −20° C. or less, −30° C. or less, −40° C. or less, or −50° C. or less.

The thermoplastic vulcanizate can have a 1% secant flexural modulus from about 300 MPa, about 600 MPa, about 800 MPa, about 1,100 MPa, or about 1,200 MPa to about 1,500 MPa, about 1,800 MPa, about 2,100 MPa, about 2,600 MPa, or about 3,000 MPa, as measured according to ASTM D 790 (A, 1.3 mm/min). For example, the TPV can have a flexural modulus from about 300 MPa to about 3,000 MPa, about 500 MPa to about 2,500 MPa, about 700 MPa to about 2,000 MPa, or about 900 MPa to about 1,500 MPa, as measured according to ASTM D 790 (A, 1.3 mm/min).

The thermoplastic vulcanizate can have a notched Izod impact strength at 23° C. of about 2.5 KJ/m² or more, about 5 KJ/m² or more, about 7.5 KJ/m² or more, about 10 KJ/m² or more, about 15 KJ/m² or more, about 20 KJ/m² or more, about 25 KJ/m² or more, or about 50 KJ/m² or more, as measured according to ASTM D 256 (Method A). For example, the thermoplastic vulcanizate can have a notched Izod impact strength at 23° C. from about 3 KJ/m², about 6 KJ/m², about 12 KJ/m² or about 18 KJ/m² to about 30 KJ/m², about 35 KJ/m², about 45 KJ/m², about 55 KJ/m², or about 65 KJ/m², as measured according to ASTM D 256 (Method A).

The thermoplastic vulcanizate can have a Gardner impact strength at −30° C. from about 2 KJ/m², about 3 KJ/m², about 6 KJ/m², about 12 KJ/m², or about 20 KJ/m² to about 55 KJ/m², about 65 KJ/m², about 75 KJ/m², about 85 KJ/m², about 95 KJ/m², or about 105 KJ/m², as measured according to ASTM D 5420 (GC). For example, the thermoplastic vulcanizate can have a Gardner impact strength at −30° C. of about 2 KJ/m² to about 100 KJ/m², about 3 KJ/m² to about 80 KJ/m², or about 4 KJ/m² to about 60 KJ/m², as measured according to ASTM D 5420 (GC).

The thermoplastic vulcanizate can have a heat deflection temperature (HDT) from about 75° C., about 83° C., about 87° C., or about 92° C. to about 95° C., about 100° C., about 105° C., or about 120° C., as measured according to ASTM D 648 (0.45 MPa). For example, the thermoplastic vulcanizate can have a heat deflection temperature of about 80° C. or more, about 85° C. or more, about 90° C. or more, or about 95° C. or more, as measured according to ASTM D 648 (0.45 MPa).

The thermoplastic vulcanizate can have a Shore hardness from about 20 Shore A about 30 Shore A, about 50 Shore A, about 55 Shore A, or about 60 Shore A to about 80 Shore A MPa, about 40 Shore D about 50 Shore D, about 55 Shore D, or about 60 Shore D, as measured according to ASTM D2240. For example, the TPV can have a Shore hardness from about 20 Shore A to about 60 Shore D, about 40 Shore A to about 55 Shore D, about 50 Shore A to about 60 Shore A, or about 80 Shore A to about 40 Shore D, as measured according to ASTM D2240.

The thermoplastic vulcanizate can have a Young's Modulus from about 800 MPa, about 900 MPa, about 1,000 MPa, about 1,100 MPa, or about 1,200 MPa to about 1,500 MPa, about 1,800 MPa, about 2,100 MPa, about 2,600 MPa, or about 3,000 MPa, as measured according to ASTM D 638. For example, the TPV can have a Young's Modulus from about 800 MPa to about 3,000 MPa, about 900 MPa to about 2,500 MPa, about 1,000 MPa to about 2,000 MPa, or about 1100 MPa to about 1,500 MPa, as measured according to ASTM D 638.

The thermoplastic vulcanizate can have a tensile strength at yield from about 14 MPa, about 15 MPa, about 16 MPa, about 17 MPa, or about 18 MPa to about 20 MPa, about 22 MPa, about 24 MPa, about 26 MPa, or about 30 MPa, as measured according to ASTM D 638. For example, the TPV can have a tensile strength at yield from about 14 MPa to about 30 MPa, about 15 MPa to about 26 MPa, or about 16 MPa to about 24 MPa, as measured according to ASTM D 638. In some embodiments, the thermoplastic vulcanizate has a tensile strength at yield of about 14 MPa or greater, about 15 MPa or greater, about 16 MPa or greater, about 17 MPa or greater, or about 18 MPa or greater, as measured according to ASTM D 638.

The thermoplastic vulcanizate can have a elongation at yield from about 1%, about 2%, about 3%, about 4%, or about 5% to about 5%, about 6%, about 7%, about 8%, about 9%, about 10%, about 11%, about 12%, about 13%, about 14%, about 15%, about 16%, about 17%, about 18%, about 19%, or about 20%, as measured according to ASTM D 638. For example, the TPV can have a elongation at yield from about 1% to about 15%, about 2% to about 10%, about 2% to about 8%, or about 3% to about 6%, as measured according to ASTM D 638. In some embodiments, the thermoplastic vulcanizate has a elongation at yield of about 5% or less, about 6% or less, about 7% or less, about 8% or less, about 9% or less, or about 10% or less, as measured according to ASTM D 638.

The thermoplastic vulcanizate can have a tensile strength at break from about 10 MPa, about 12 MPa, about 13 MPa, about 14 MPa, about 15 MPa, or about 16 MPa to about 20 MPa, about 22 MPa, about 24 MPa, about 26 MPa, or about 30 MPa, as measured according to ASTM D 638. For example, the TPV can have a tensile strength at break from about 10 MPa to about 30 MPa, about 12 MPa to about 26 MPa, or about 16 MPa to about 24 MPa, as measured according to ASTM D 638. In some embodiments, the thermoplastic vulcanizate has a tensile strength at break of about 12 MPa or greater, about 13 MPa or greater, about 14 MPa or greater, about 15 MPa or greater, or about 16 MPa or greater, as measured according to ASTM D 638.

The thermoplastic vulcanizate can have a tension set from about 1%, about 2%, about 3%, about 4%, or about 5% to about 5%, about 6%, about 7%, about 8%, about 9%, about 10%, about 11%, about 12%, about 13%, about 14%, about 15%, about 16%, about 17%, about 18%, about 19%, or about 20%, as measured according to ASTM D 638. For example, the TPV can have a tension set from about 1% to about 15%, about 2% to about 10%, about 2% to about 8%, or about 3% to about 6%, as measured according to ASTM D 638. In some embodiments, the thermoplastic vulcanizate has a tension set of about 12% or less, about 10% or less, about 9% or less, about 8% or less, about 7% or less, or about 6% or less, as measured according to ASTM D 638.

The thermoplastic vulcanizate can have an oil swell in IRM903 from about 1%, about 2%, about 3%, about 4%, or about 5% to about 15%, about 16%, about 17%, about 18%, about 19%, about 20%, about 21%, about 22%, about 23%, about 24%, about 25%, about 26%, about 27%, about 28%, about 29%, or about 30%, as measured according to ASTM D471. For example, the TPV can have an oil swell in IRM903 from about 1% to about 30%, about 2% to about 20%, about 2% to about 18%, or about 3% to about 15%, as measured according to ASTM D471. In some embodiments, the thermoplastic vulcanizate has an oil swell of about 20% or less, about 18% or less, about 15% or less, about 13% or less, about 12% or less, or about 10% or less, as measured according to ASTM D471.

In at least one embodiment, the thermoplastic vulcanizate can have component B concentration of at least about 10 wt % to about 35 wt %, based on the combined weight of polymers, a notched Izod impact strength at 23° C. of at least 5 KJ/m² to about 75 KJ/m², and a flexural modulus less than 1,200 MPa to about 1,900 MPa. In at least one embodiment, the thermoplastic vulcanizate can have an ethylene copolymer concentration of at least about 15 wt % to about 25 wt %, based on the combined weight of the polymers, a notched Izod impact strength at 23° C. of at least 15 KJ/m² to about 65 KJ/m², and a flexural modulus less than 1,300 MPa to about 1,800 MPa.

### Catalyst Systems

In some embodiments, the ICP may be prepared using a Ziegler-Natta catalyst system with a blend of electron donors as described in U.S. Pat. No. 6,087,459 or U.S. Patent publication No. 2010/0105848, incorporated by reference. In some embodiments, the ICP may be prepared using a succinate Ziegler-Natta type catalyst system.

The ICP compositions can be prepared using a Ziegler-Natta type catalyst, a co-catalyst such as triethylaluminum (“TEA”), and optionally an electron donor including the non-limiting examples of dicyclopentyldimethoxysilane (“DCPMS”), cyclohexylmethyldimethoxysilane (“CMDMS”), diisopropyldimethoxysilane (“DIPDMS”), di-t-butyldimethoxysilane, cyclohexylisopropyldimethoxysilane, n-butylmethyldimethoxysilane, tetraethoxysilane, 3,3,3-trifluoropropylmethyldimethoxysilane, mono and di-alkylaminotrialkoxysilanes or other electron donors or combination(s) thereof. Examples of different generation Ziegler-Natta catalysts that may be suitable for use are described in the “Polypropylene Handbook” by Nello Pasquini, 2^{nd} Edition, 2005, Chapter 2 and include, phthalate-based, di-ether based, succinate-based catalysts or combinations thereof.

Metallocene-based catalyst systems may also be used to produce the ICP. suitable metallocenes include are those in the generic class of bridged, substituted bis(cyclopentadienyl) metallocenes, such as bridged, substituted bis(indenyl) metallocenes that may to produce high molecular weight, high melting, highly isotactic propylene polymers. Examples of bridged, substituted bis(indenyl) metallocenes suitable may be found in U.S. Pat. No. 5,770,753, incorporated by reference.

For example, the catalyst can be or include one or more Ziegler-Natta and/or one or more single-site, e.g., metallocene, polymerization catalysts. The catalyst(s) can be supported, e.g., for use in heterogeneous catalysis processes, or unsupported, e.g., for use in homogeneous catalysis processes. In some embodiments, component A (polypropylene) and component B (ethylene copolymer) can be made with a common supported Ziegler-Natta or single-site catalyst.

The catalyst system may have a mileage of about 30,000 gICP/gCatalyst or greater, such as about 35,000 gICP/gCatalyst or greater, or about 40,000 gICP/gCatalyst or greater.

### Component A—Polypropylene

Component A is a polypropylene. Polypropylenes (also referred to as “propylene-based polymers”) include those solid, typically high-molecular weight plastic resins that primarily include units deriving from the polymerization of propylene. In some embodiments, at least 75%, in other embodiments at least 90%, in other embodiments at least 95%, and in other embodiments at least 97% of the units of the propylene-based polymer are derived from the polymerization of propylene. Component A may be a propylene homopolymer with little or substantially no comonomer content, such as about 5 wt % or less, about 4 wt % or less, about 1 wt % or less, about 0.5 wt % or less, about 0.1 wt % or less, or about 0.05 wt % or less (substantially no comonomer).

In some embodiments, component A is a propylene homopolymer, such as an isotactic propylene homopolymer. Polypropylene homopolymer can include linear chains and/or chains with long chain branching. In some embodiments, the polymer component of component A consists essentially of propylene-derived units and does not contain comonomer except that which may be present due to impurities in the propylene feed stream.

In some embodiments, small amounts (less than 10 wt %) of a comonomer may be used in component A to obtain desired polymer properties. Typically such copolymers contain less than 10 wt %, or less than 6 wt %, or less than 4 wt %, or less than 2 wt %, or less than 1 wt % of comonomer. In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C10-C₂₀ olefins.

In some embodiments, the polypropylene includes a homopolymer, random copolymer, or impact copolymer polypropylene or combination thereof. In some embodiments, the polypropylene is a high melt strength (HMS) long chain branched (LCB) homopolymer polypropylene.

In some embodiments, the propylene homopolymer or random copolymer process utilizes one or two liquid filled loop reactors in series. The term liquid or bulk phase reactor is intended to encompass a liquid propylene process as described by Ser van Ven in “Polypropylene and Other Polyolefins”, 1990, Elsevier Science Publishing Company, Inc., pp. 119-125. The propylene homopolymer or random copolymer may also be prepared in a gas-phase reactor, a series of gas phase reactors or a combination of liquid filled loop reactors and gas phase reactors in any suitable sequence as described in U.S. Pat. No. 7,217,772, incorporated by reference. The propylene-based polymers may be synthesized by using an appropriate polymerization techniques such as Ziegler-Natta type polymerizations, and catalysis employing single-site organometallic catalysts including metallocene catalysts.

Propylene based polymer crystallinity and isotacticity and, therefore, the crystallinity and tacticity of component A can be controlled by the ratio of co-catalyst to electron donor, and the type of co-catalyst/donor system and is also affected by the polymerization temperature. The appropriate ratio of co-catalyst to electron donor is dependent upon the catalyst/donor system selected.

Examples of polypropylene suitable for ICP blends may include ExxonMobil™ PP5341 (available from ExxonMobil); Achieve™ PP6282NE1 (available from ExxonMobil) and/or polypropylene resins with broad molecular weight distribution as described in U.S. Pat. Nos. 9,453,093 and 9,464,178; and other polypropylene resins described in US20180016414 and US20180051160; additional examples may include Waymax MFX6 (available from Japan Polypropylene Corp.); Borealis Daploy™ WB140 (available from Borealis AG); Braskem Ampleo 1025MA and Braskem Ampleo 1020GA (available from Braskem Ampleo); and Sabic PP-UMS HEX17112 or Sabic PP571P (available from SABIC).

The amount of hydrogen necessary to prepare propylene-based component A is dependent in large measure on the donor and catalyst system used. Examples of propylene-based matrix include, but are not limited to, homopolymer polypropylene and random ethylene-propylene or random propylene-alpha olefin copolymer, where the comonomer includes, but is not limited to, C4, C6 or C8 alpha olefins or combinations thereof.

### Component A Properties

The polymerization of propylene and, if present, other monomer(s) to produce component A can form particles having a weight average particle size along the longest cross-sectional length thereof from about 0.01 mm, about 0.05 mm, about 0.1 mm, about 0.3 mm, or about 0.5 mm to about 2 mm, about 3 mm, about 4 mm, about 5 mm, or about 6 mm. For example, the particles can have a weight average particle size along the longest cross-sectional length thereof of from about 0.05 mm to about 5 mm, about 0.1 mm to about 4 mm, about 1 mm to about 4.5 mm, about 1.5 mm to about 3 mm, about 2 mm to about 4 mm, or about 0.2 mm to about 3.5 mm.

The particles can also have one or more pores formed within and/or through. The polypropylene particles can have a pore volume of less than 80%, less than 75%, less than 70%, less than 60%, less than 50%, or less than 40%. For example, the particles can have a pore volume from about 5%, about 10%, about 15%, or about 20% to about 55%, about 65%, about 75%, about 80%, about 85%, or about 90%. In some embodiments, the particles have a pore volume of less than 80%.

The pores formed in and/or through the particles may have an average volume from about 10⁻⁹ mm³, about 10⁻⁸ mm³, about 10⁻⁷ mm³, or about 10⁻⁵ mm³, to about 10⁻³ mm³, about 10⁻² mm3, about 10⁻¹ mm³, about 1 mm³, or about 10 mm³. For example, the polypropylene particles can have pores having an average volume of about 10⁻⁹ mm³ to about 10 mm³, about 10⁻⁷ mm³ to about 10⁻² mm³, or about 10⁻⁵ mm³ to about 10⁻⁴ mm³.

The pores formed in and/or through the particles may have a cross-sectional length or in the case of spherical pores a diameter from about 10⁻⁶ mm, about 10⁻⁵ mm, about 10⁴ mm, or about 10⁻³ mm to about 10⁻³ mm, about 10⁻² mm, about 10⁻¹ mm, about 1 mm, or about 10 mm.

In some embodiments, the component A includes one or more of the following characteristics:

1) Component A weight average molecular weight (Mw) from about 50,000 g/mol to about 2,000,000 g/mol, such as from about 100,000 g/mol to about 1,000,000 g/mol, from about 100,000 g/mol to about 600,000 g/mol, or from about 400,000 g/mol to about 800,000 g/mol, as measured by gel permeation chromatography (GPC) with polystyrene standards.
2) Component A may have a number average molecular weight (Mn) from about 25,000 g/mol to about 1,000,000 g/mol, such as from about 50,000 g/mol to about 300,000 g/mol as measured by GPC with polystyrene standards.
3) Component A may have a Z average molecular weight (Mz) from about 75,000 g/mol to about 3,000,000 g/mol, such as from about 100,000 g/mol to about 2,000,000 g/mol as measured by GPC with polystyrene standards.
4) Component A may have a broad polydispersity index, Mw/Mn (“PDI”), of about 4.5 or greater, about 5 or greater, about 5.5 or greater, or about 6 or greater. In some embodiments, component A has a PDI of about 15 or less, about 14 or less, about 13 or less, about 12 or less, about 11 or less, about 10 or less, about 9.5 or less, or about 9 or less. In some embodiments, component A has a PDI from about 4.5 to about 15, such as from about 4.5 to about 12, from about 5 to about 10, or from about 6 to about 9. In some embodiments, these polydispersity indices are obtained in the absence of visbreaking using peroxide or other post reactor treatment designed to reduce molecular weight.
5) Component A may have an Mz/Mw ratio of about 2.5 or greater, about 2.6 or greater, about 2.7 or greater, about 2.8 or greater, about 2.9 or greater, about 3 or greater, about 3.1 or greater, or about 3.2 or greater. Component A may have an Mz/Mw ratio of about 7 or less, about 6.5 or less, about 6 or less, about 5.5 or less, or about 5 or less.
6) Component A may have a melting point (Tₘ) that is from about 110° C. to about 170° C., such as from about 140° C. to about 168° C., or from about 160° C. to about 165° C., as determined by ISO 11357-1,2,3.
7) Component A may have a glass transition temperature (T_{g}) that is from about −50° C. to about 10° C., such as from about −30° C. to about 5° C., or from about −20° C. to about 2° C., as determined by ISO 11357-1,2,3.
8) Component A may have a crystallization temperature (Tc) that is about 75° C. or more, such as about 95° C. or more, about 100° C. or more, about 105° C. or more, or from about 105° C. to about 130° C.), as determined by ISO 11357-1,2,3
9) Component A may have a melt flow rate (MFR) from about 0.1 g/10 min to about 500 g/10 min, such as from about 0.2 g/10 min to about 200 g/10 min, from about 0.5 g/10 min to about 175 g/10 min, from about 1 g/10 min to about 160 g/10 min, from about 1.5 g/10 min to about 150 g/10 min, or from about 3 to about 100 g/10 min. The MFR may be determined by ASTM-1238 measured at load of 2.16 kg and 230° C.
10) Component A may have a heat of fusion (Hf) that is about 52.3 J/g or more, such as about 100 J/g or more, about 125 J/g or more, or about 140 J/g or more.
11) Component A may have a g′ᵥᵢₛ that is about 1 or less, such as about 0.9 or less, about 0.8 or less, about 0.6 or less, or about 0.5 or less).

In some embodiments, component A includes a homopolymer of a high-crystallinity isotactic or syndiotactic polypropylene. Component A can have a density of from about 0.89 g/cc³ to about 0.91 g/cc³, with the largely isotactic polypropylene having a density of from about 0.90 g/cc³ to about 0.91 g/cc³. Also, high and ultra-high molecular weight polypropylene that has a fractional melt flow rate can be employed. In some embodiments, polypropylene resins may be characterized by a MFR (ASTM D-1238; 2.16 kg @ 230° C.) that is about 10 g/10 min or less, such as about 1 g/10 min or less, or about 0.5 g/10 min or less.

### Component B—Copolymer

Component B is formed by the polymerization of ethylene, propylene, and at least one α,ω-diene. Component B includes those solid, typically high-molecular weight resins that include units derived from the polymerization of ethylene, units derived from polymerization of propylene, and units derived from polymerization of at least one α,ω-diene. In some embodiments, component B may also include units deriving from the polymerization of additional α-olefins such as 1-butene, 1-hexene, 1-octene, 2-methyl-1-propene, 3-methyl-1-pentene, 4-methyl-1-pentene, 5-methyl-1-hexene, and mixtures thereof.

An α,ω-diene is a hydrocarbon with two or more carbon-carbon double-bonds at an end of a chain or branch. Example α,ω-dienes include unbranched hydrocarbons with an alkene at each terminus of the carbon chain, such as 1,3-butadiene, 1,4-pentadiene, 1,5-hexadiene, 1,6-heptadiene, 1,7-octadiene, 1,8-nondiene, 1,9-decadiene, 1,10-undecadiene, 1,11-dodecadiene, 1,12-tridecadiene, 1,13-tetradecadiene, 1,14-pentadecadiene, or 1,15-hexadecadiene. Furthermore, α,ω-dienes may include substituted or branched versions of hydrocarbons with an alkene at each terminus of a carbon chain discussed above. Additionally, α,ω-dienes may include carbon chains that include aromatics, heterocycles, and/or other cyclics, such as divinylbenzene (para, meta, ortho, or combination(s) of isomers), 1,2-divinylcyclohexane, 1,3-divinylcyclopentane, or 1,4-divinylfuran. Additionally, α,ω-dienes may include chains with two or more vinyl terminations including any suitable combination of linear aliphatic, branched aliphatic, aromatics, heterocycles, and/or cyclic aliphatic.

Methods of making the component B can be slurry, solution, gas-phase, high-pressure, or other suitable processes, through the use of catalyst systems appropriate for the polymerization of polyolefins, such as Ziegler-Natta catalysts, metallocene catalysts, other appropriate catalyst systems, or combinations thereof.

For example, component B may be produced using a metallocene catalyst system, such as a mono- or bis-cyclopentadienyl transition metal catalyst in combination with an activator of alumoxane and/or a non-coordinating anion in solution, slurry, high-pressure, or gas-phase. The catalyst and activator may be supported or unsupported and the cyclopentadienyl rings may be substituted or unsubstituted. Information on methods and catalysts/activators to produce such mPE homopolymers and copolymers is available in WO 1994/26816; WO 1994/03506; U.S. Pat. Nos. 5,153,157; 5,198,401; 5,240,894; 5,017,714; CA 1,268,753; U.S. Pat. Nos. 5,324,800; 5,264,405; WO 1992/00333; U.S. Pat. Nos. 5,096,867; 5,507,475; WO 1991/09882; WO 1994/03506; and U.S. Pat. No. 5,055,438.

Additionally, component B can be synthesized by employing solution, slurry, or gas phase polymerization techniques or combination(s) thereof that employ various catalyst systems including Ziegler-Natta systems including vanadium. Exemplary catalysts include single-site catalysts including constrained geometry catalysts involving Group IV-VI metallocenes. In some embodiments, component B can be produced via Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed.

In some embodiments, component B is a copolymer including propylene, α,ω-diene, and other comonomer-derived units. In such embodiments, the other comonomer may be an α-olefin, such as ethylene, 1-butene, 1-hexene, 1-octene, 2-methyl-1-propene, 3-methyl-1-pentene, 4-methyl-1-pentene, 5-methyl-1-hexene, and mixtures thereof. In some embodiments, component B is a terpolymer of propylene, ethylene, and α,ω-diene. Other propylene copolymers or terpolymers may be suitable depending on the product properties desired. For example, in conjunction with an α,ω-diene, propylene/butene, hexene, or octene copolymers may be used.

Component B may include a propylene content in about 20 wt % or more, about 30 wt % or more, about 35 wt % or more, about 40 wt % or more, about 45 wt % or more, about 50 wt % or more, or about 60 wt % or more. Additionally, component B may include a propylene content at about 90 wt % or less, about 85 wt % or less, about 80 wt % or less, about 75 wt % or less, about 70 wt % or less, or about 65 wt % or less. For example, component B may include a propylene content from about 30 wt % to about 80 wt %, from about 35 wt % to about 70 wt %, from about 40 wt % to about 65 wt %, or from about 60 wt % to about 80 wt %.

Component B may have an ethylene content of about 20 wt % or more, about 25 wt % or more, about 30 wt % or more, about 35 wt % or more, about 40 wt % or more, or about 45 wt % or more. Additionally, component B may have an ethylene content of about 85 wt % or less, about 80 wt % or less, about 75 wt % or less, about 70 wt % or less, about 65 wt % or less, about 60 wt % or less, or about 55 wt % or less. For example, component B may have an ethylene content from about 20 wt % to about 80 wt %, from about 25 wt % to about 75 wt %, from about 30 wt % to about 70 wt %, from about 35 wt % to about 65 wt %, from about 40 wt % to about 60 wt %, from about 45 wt % to about 55 wt %, or from about 20 wt % to about 45 wt %.

Component B can have an α,ω-diene content from about 5 wt %, about 8 wt %, about 10 wt %, or about 15 wt % to about 25 wt %, about 30 wt %, about 38 wt %, or about 42 wt %. For example, component B can have an α,ω-diene content from about 5 wt % to about 40 wt %, such as from about 6 wt % to about 35 wt %, from about 7 wt % to about 30 wt %, or from about 8 wt % to about 30 wt %.

For the copolymerization reaction, the gas phase composition of the reactor(s) is maintained such that the ratio of the moles of ethylene in the gas phase to the total moles of propylene, ethylene and α,ω-diene is held constant. In order to maintain the desired molar ratio and bi-polymer content, monomer feeds of propylene, ethylene, and α,ω-diene may be adjusted. Additionally, for the copolymerization reaction, the gas phase composition of the reactor(s) is maintained such that the ratio of the moles of α,ω-diene in the gas phase to the total moles of propylene, ethylene and α,ω-diene is held constant. In order to maintain the desired molar ratio and monomer content, monomer feeds of propylene, ethylene and α,ω-diene may be adjusted.

Without wishing to be bound by theory, it is believed that the catalyst resides, occupies or at least partially resides or occupies within the pores or along the inner walls of the pores that are at least partially formed in or through the polypropylene particles. Accordingly, it is believed that the polymerization of the ethylene and the at least one comonomer, or at least a majority of the polymerization of the ethylene and the at least one comonomer, occurs within the pores of the polypropylene particles as opposed to outside or external the polypropylene particles. Thus, the resulting impact copolymer can be in the form of polymer particles having a continuous phase composed of the polypropylene particles with a disperse, discontinuous, or occluded phase made up of the ethylene copolymer. For example, the ethylene copolymer component can at least partially occupy one or more of the pores that were present in the polypropylene polymer particles prior to polymerization of the ethylene and comonomer therein.

Hydrogen may be optionally added in the gas phase reactor(s) to control the Mw and, therefore, the intrinsic viscosity of the ICP. The composition of the gas phase is maintained such that the ratio of hydrogen to ethylene (mol/mol) referred to as R, is held constant. Similarly to the hydrogen control in the loops, the H₂/C₂ that achieves a target IV will depend on the catalyst and donor system. Component B may be a unimodal copolymer rubber, meaning a copolymer rubber of uniform IV and composition in co-monomers, or a bimodal or multi-modal rubber copolymer, such as copolymer rubber with components of different IV or composition in co-monomer or type of co-monomer(s) or combinations thereof.

### Component B Properties

Component B may have one or more of the following properties:

1) Component B may have a density of about 0.915 g/cm³ or less, such as about 0.910 g/cm³ or less, or about 0.905 g/cm³ or less, or about 0.902 g/cm³ or less; and about 0.85 g/cm³ or more, about 0.86 g/cm³ or more, about 0.87 g/cm³ or more, about 0.88 g/cm³ or more, or about 0.885 g/cm³ or more, such as from about 0.85 g/cm³ to about 0.915 g/cm³, from about 0.86 g/cm³ to about 0.91 g/cm³, from about 0.87 g/cm³ to about 0.91 g/cm³, from about 0.88 g/cm³ to about 0.905 g/cm³, from about 0.88 g/cm³ to about 0.902 g/cm³, or from about 0.885 g/cm³ to about 0.902 g/cm³.
2) Component B may have a heat of fusion (Hf) of about 90 J/g or less, such as about 70 J/g or less, about 50 J/g or less, or about 30 J/g or less, such as from about 10 J/g to about 70 J/g, from about 10 J/g to about 50 J/g, or from about 10 J/g to about 30 J/g);
3) Component B may have a crystallinity of about 40% or less, such as about 30% or less, or about 20% or less and about 5% or more. For example, component B may have crystallinity from about 5 to about 30%, or from about 5 to about 20%.
4) Component B may have a melting point (Tₘ, peak first melt) of about 100° C. or less, such as about 95° C. or less, about 90° C. or less, about 80° C. or less, about 70° C. or less, about 60° C. or less, or about 50° C. or less.
5) Component B may have a crystallization temperature (Tc, peak) of about 90° C. or less, such as about 80° C. or less, about 70° C. or less, about 60° C. or less, about 50° C. or less, or about 40° C. or less.
6) Component B may have a glass transition temperature (T_{g}), as determined by Differential Scanning Calorimetry (DSC) according to ASTM E 1356, that is about −20° C. or less (such as about −30° C. or less, or about −50° C. or less). In some embodiments, T_{g} is from about −60° C. to about −20° C.
7) Component B may have a dry Mooney viscosity (ML₍₁₊₄₎ at 125° C.) per ASTM D-1646, that is from about 10 MU to about 500 MU, such as from about 50 MU to about 450 MU. In some embodiments, the Mooney viscosity is 250 MU or more, such as 350 MU or more.
8) Component B may have an Mw of about 30 to about 2,000 kg/mol, such as about 50 kg/mol to about 1,000 kg/mol, or about 90 to about 500 kg/mol.
9) Component B may have a melt index (MI_{2.16}) at 190° C. of about 0.1 g/10 min to about 100 g/10 min, such as about 0.3 g·10 min to about 60 g/10 min, or about 0.5 g/10 min to about 40 g/10 min, or about 0.7 g/10 min to about 20 g/10 min).
10) Component B may have a CDBI of about 60 wt % or more, such as about 70 wt % or more, about 80 wt % or more, about 90 wt % or more, or about 95 wt % or more.
11) Component B may have a g′ᵥᵢₛ that is about 0.8 or more, such as about 0.85 or more, about 0.9 or more, about 0.95 or more. For example, component B may have a g′ᵥᵢₛ that is about 0.96, about 0.97, about 0.98, about 0.99, or about 1.
12) Component B may have a long-chain branching index at 125° C., that is about 5 or less, such as about 4 or less, about 3 or less, about 2.5 or less, about 2 or less, about 1.5 or less. A long-chain branching index is defined based on large amplitude oscillatory shear measurements using a strain of 1000%, and frequency of 0.6 rad/s.
13) Component B may have an intrinsic viscosity greater than about 1 dl/g, or greater than about 1.5 dl/g, or greater than about 1.75 dl/g. Component B may have an intrinsic viscosity of less than 5 dl/g, or less than 4 dl/g, or less than 3.5 dl/g.
14) Component B may have a vinyl content, which is vinyl groups per 1000 Carbon atoms as measured by H¹-NMR from about 0.01 to about 5, such as from about 0.01 to about 2.5, from about 0.05 to about 1, or from about 0.1 to about 0.75.

### Additional Additives

A variety of additives may be incorporated into the ICP for various purposes. For example, such additives may include, stabilizers, plasticizers, oils, antioxidants, fillers, colorants, nucleating agents, extenders, pigmentation agents, and mold release agents. Plasticizers may include esters or polyesters. Oils may include synthetic oil or mineral oil, such as an aromatic oil, a naphthenic oil, a paraffinic oil, an isoparaffinic oil, or combination(s) thereof. Primary and secondary antioxidants may include, for example, hindered phenols, hindered amines, and phosphates. Nucleating agents may include, for example, sodium benzoate, and talc. Dispersing agents such as Acrowax C may also be included. Slip agents may include, for example, oleamide, and erucamide. Catalyst deactivators may also be used, for example, calcium stearate, hydrotalcite, and calcium oxide. Fillers may include inorganics, such as calcium carbonate, clays, silica, talc, and/or titanium dioxide.

Optionally, additional external donor may be added in the gas phase copolymerization process (second stage) as described in U.S. 2006/0217502. The external donor added in the second stage may be the same or different from the external donor added to the first stage. In some embodiments, external donor is added only on the first stage.

A suitable organic compound/agent such as antistatic inhibitor or combination of organic compounds/agents are also added in stage 2, e.g., as described in U.S. 2006/0217502, U.S. 2005/0203259 and U.S. 2008/0161510 A1 and U.S. Pat. No. 5,410,002. Examples of antistatic inhibitors or organic compounds include, but are not limited to, chemical derivatives of hydroxylethyl alkylamine available under the trade names ATMER® 163 and ARMOSTAT® 410 LM, a major antistatic agent including at least one polyoxyethylalkylamine in combination with one minor antistatic agent including at least one fatty acid sarcosinate or similar compounds or combination(s) thereof.

Additives such as antioxidants and stabilizers (including UV stabilizers and other UV absorbers, such as chain-breaking antioxidants), fillers (such as mineral aggregates, fibers, clays, and the like), nucleating agents, slip agents, block, antiblock, pigments, dyes, color masterbatches, waxes, processing aids (including pine or coal tars or resins and asphalts), neutralizers (such as hydro talcite), adjuvants, oils, lubricants, low molecular weight resins, surfactants, acid scavengers, anticorrosion agents, cavitating agents, blowing agents, quenchers, antistatic agents, cure or cross linking agents or systems (such as elemental sulfur, organo-sulfur compounds, and organic peroxides), fire retardants, coupling agents (such as silane), and combinations thereof may also be present in the impact copolymer compositions. Typical additives used in polypropylene and polypropylene blends are described in POLYPROPYLENE HANDBOOK 2^{ND} ED., N. Pasquini, ed. (Hanser Publishers, 2005). Additives may be present in amounts from about 0.001 wt % to about 50 wt %, such as from about 0.01 wt % to about 20 wt %, about 0.1 wt % to about 10 wt %, or about 0.1 wt % to about 1 wt %, based upon the weight of the ICP. Pigments, dyes, and other colorants may be present from about 0.01 wt % to about 10 wt %, such as about 0.1 wt % to about 6 wt %.

In some embodiments, the TPV may include carbon black. Carbon black from a variety of sources may be used, such as acetylene black, channel black, furnace black, lamp black, thermal black and may be produced by incomplete combustion of petroleum products. Typical carbon black particle diameters are from about 5, 10, 15, 20, 25, 30, 35, and 40 nm to about 50, 60, 70, 80, 90, 100, 110, 120, 130, 140, 150, 160, 170, 180, 190, 200, 210, 220, 230, 240, 250, 260, 270, 280, 290, 300, 310, 320, and 330 nm. Carbon black particles may form aggregates ranging in size (e.g., diameter when the aggregate is approximated as a sphere) from about 90, 95, 100, 105, 110, and 115 nm to about 200, 250, 300, 350, 400, 450, 500, 550, 600, 650, 700, 750, 800, 850, and 900 nm, and/or agglomerates ranging in size from about 1, 2, 3, 4, 5, 6, 7, 8, 9, and 10 microns to about 90, 100, 150, 200, 250, 300, 350, and 400 microns, or larger. In some embodiments, the carbon black imparts UV protection and/or coloring (i.e., black pigmentation) to a TPV.

The term “additives” includes, for example, stabilizers, surfactants, antioxidants, anti-ozonants (e.g., thioureas), fillers, colorants, nucleating agents, anti-block agents, UV-blockers/absorbers, coagents (cross-linkers and cross-link enhancers), hydrocarbon resins (e.g., Oppera™ resins), and slip additives and combinations thereof. Primary and secondary antioxidants include, for example, hindered phenols, hindered amines, and phosphates. Slip agents include, for example, oleamide and erucamide. Examples of fillers include carbon black, clay, talc, calcium carbonate, mica, silica, silicate, titanium dioxide, organic and inorganic nanoscopic fillers, and combination(s) thereof. Other additives include dispersing agents and catalyst deactivators such as calcium stearate, hydrotalcite, and calcium oxide, and/or other acid neutralizers. In certain embodiments, cross-linkers and cross-link enhancers are absent from the propylene impact copolymers.

In some embodiments, the impact copolymer can be blended with one or more additional polymeric additives in amounts of about 25 wt % or less, such as about 20 wt % or less, about 15 wt % or less, about 10 wt % or less, or about 5 wt % or less. For example, the impact copolymer can be blended with one or more additional polymeric additives in amounts of about 0.5 wt % to about 25 wt %, such as about 0.75 wt % to about 20 wt %, about 1 wt % to about 15 wt %, about 1.5 wt % to about 10 wt %, or about 2 wt % to about 5 wt %, based upon the weight of the ICP. Suitable polymers useful as polymeric additives can include, but are not limited to, polyethylenes, including copolymers of ethylene and one or more polar monomers, such as vinyl acetate, methyl acrylate, n-butyl acrylate, acrylic acid, and vinyl alcohol (e.g., EVA, EMA, EnBA, EAA, and EVOH); ethylene homopolymers and copolymers synthesized using a high-pressure free radical process, including LDPE; copolymers of ethylene and C3 to C40 olefins, such as propylene and/or butene, with a density of about 0.91 g/cm³ to about 0.94 g/cm³, including LLDPE; and high density PE, about 0.94 g/cm³ to about 0.98 g/cm³. Suitable polymers can also include polybutene-1 and copolymers of polybutene-1 with ethylene and/or propylene. Suitable polymers can also include non-EP Rubber Elastomers. Non-EP Rubber Elastomers can include Polyisobutylene, butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, and polybutadiene rubber (both cis and trans). Other suitable polymers can include low-crystallinity propylene/olefin copolymers, such as random copolymers. The low-crystallinity or random copolymer can have about 70 wt % or more propylene and about 5 wt % to about 30 wt % comonomer, such as about 5 wt % to about 20 wt % of comonomer selected from ethylene and C4 to C12 olefins. The polymers can be made via a metallocene-type catalyst; and may have one or more of the following properties: a) a Mw of about 20 kg/mol to about 5,000 kg/mol, such as about 30 kg/mol to about 2,000 kg/mol, about 40 kg/mol to about 1,000 kg/mol, about 50 kg/mol to about 500 kg/mol, or about 60 kg/mol to about 400 kg/mol; b) a polydispersity index (Mw/Mn) of about 1.5 to about 10, such as about 1.7 to about 5, or about 1.8 to about 3; c) a branching index (g′) of about 0.9 or greater, such as about 0.95 or greater, or about 0.99 or greater; d) a density of about 0.85 g/cm³ to about 0.90 g/cm³, such as about 0.855 g/cm³ to about 0.89 g/cm³, or about 0.86 g/cm³ to about 0.88 g/cm³; e) a melt flow rate (MFR) of about 0.2 g/10 min ore greater, such as about 1 g/10 min to about 500 g/10 min, or about 2 g/10 min to about 300 g/10 min; f) a heat of fusion (Hf) of about 0.5 J/g or more, such as about 1 J/g or more, about 2.5 J/g or more, or about 5 J/g or more and about 75 J/g or less, such as about 50 J/g or less, about 35 J/g or less, or about 25 J/g or less; g) a DSC-determined crystallinity of from about 1 wt % to about 30 wt %, such as about 2 wt % to about 25 wt %, about 2 wt % to about 20 wt %, or about 3 wt % to about 15 wt %; h) a single broad melting transition with a peak melting point of about 25° C. to about 105° C., such as about 25° C. to about 85° C., about 30° C. to about 70° C., or about 30° C. to about 60° C., where the highest peak is considered the melting point; i) a crystallization temperature (Tc) of about 90° C. or less, such as about 60° C. or less; j)¹³C-NMR-determined propylene tacticity index of more than 1; and/or k)¹³C-NMR-determined mm triad tacticity index of about 75% or greater, such as about 80% or greater, about 82% or greater, about 85% or greater, or about 90% or greater.

Useful low-crystallinity propylene/olefin copolymers that may be used as additives are available from ExxonMobil Chemical; suitable examples include Vistamaxx™ 6100, Vistamaxx™ 6200 and Vistamaxx™ 3000. Other useful low-crystallinity propylene/olefin copolymers are described in WO Publication Nos. WO 03/040095, WO 03/040201, WO 03/040233, and WO 03/040442, all to Dow Chemical, which disclose propylene-ethylene copolymers made with non-metallocene catalyst compounds. Still other useful low-crystallinity propylene/olefin copolymers are described in U.S. Pat. No. 5,504,172 to Mitsui Petrochemical. Low-crystallinity propylene/olefin copolymers are described in U.S. Publication No. 2002/0004575. Other suitable polymers can include propylene oligomers suitable for adhesive applications, such as those described in WO Publication No. WO 2004/046214, including those described in pages 8 to 23. Still other suitable polymers can include Olefin block copolymers, including those described in WO Publication Nos. WO 2005/090425, WO 2005/090426, and WO 2005/090427. Other suitable polymers can include polyolefins that have been post-reactor functionalized with maleic anhydride (so-called maleated polyolefins), including maleated ethylene polymers, maleated EP Rubbers, and maleated propylene polymers. In some embodiments, the amount of free acid groups present in the maleated polyolefin is less than about 1,000 ppm, such as less than about 500 ppm, or less than about 100 ppm, and the amount of phosphite present in the maleated polyolefin is less than 100 ppm. Other suitable polymers can include Styrenic Block Copolymers (SBCs), including: Unhydrogenated SBCs such as SI, SIS, SB, SBS, SIBS and the like, where S=styrene, I=isobutylene, and B=butadiene; and hydrogenated SBCs, such as SEBS, where EB=ethylene/butene. Other suitable polymers can include Engineering Thermoplastics, for example: Polycarbonates, such as poly(bisphenol-a carbonate); polyamide resins, such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, and nylon 66/PPS copolymer; polyester resins, such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer, and other aromatic polyesters; nitrile resins, such as polyacrylonitrile (PAN), polymethacrylonitrile, styrene-acrylonitrile copolymers (SAN), methacrylonitrile-styrene copolymers, and methacrylonitrile-styrene-butadiene copolymers; acrylate resins, such as polymethyl methacrylate and polyethylacrylate; polyvinyl acetate (PVAc); polyvinyl alcohol (PVA); chloride resins, such as polyvinylidene chloride (PVDC), and polyvinyl chloride (PVC); fluoride resins, such as polyvinylidene fluoride (PVDF), polyvinyl fluoride (PVF), polychlorofluoroethylene (PCFE), and polytetrafluoroethylene (PTFE); cellulose resins, such as cellulose acetate and cellulose acetate butyrate; polyimide resins, including aromatic polyimides; polysulfones; polyacetals; polylactones; polyketones, including aromatic polyketones; polyphenylene oxide; polyphenylene sulfide; styrene resins, including polystyrene, styrene-maleic anhydride copolymers, and acrylonitrile-butadiene-styrene resin.

In some embodiments, a thermoplastic vulcanizate can include no added polymeric additives, or if present the polymeric additives can be present at about 0.5 wt % or less.

In some embodiments, the thermoplastic vulcanizate can include less than 10 wt % LLDPE having a density of 0.912 g/cm³ to 0.935 g/cm³, such as about 5 wt % or less, about 1 wt % or less, or about 0.1 wt % or less, based upon the total weight of the TPV.

### Articles of Manufacture

The TPV can be formed by any suitable means into articles of manufacture such as automotive components, pallets, crates, cartons, appliance components, sports equipment and other articles that would strength and elasticity. The thermoplastic vulcanizate can include from about 200 ppm to about 1,500 ppm of a nucleating agent. The presence of nucleating agents can benefit the TPV by reducing the crystallization rate and hence improve the cycle time (injection, packing, cooling and part ejection) in the injection molding process. In some embodiments, the TPVs include a nucleating agent and have a crystallization half-time at 135° C. of about 15 minutes or less, such as about 12 minutes or less, about 10 minutes or less, about 5 minutes or less, about 2 minutes or less, about 60 seconds or less, or about 40 seconds or less.

### Blends

Compositions (also referred to as “blends”) of the present disclosure may be produced by mixing the component A polymer, the component B polymer, and optional additives together, by one or more of connecting reactors together in series to make reactor blends or by using more than one catalyst, for example, a dual metallocene catalyst, in the same reactor to produce multiple species of polymer. Additionally or alternatively, the polymers can be mixed together prior to being put into an extruder or may be mixed in an extruder.

The compositions may be formed by dry blending the individual components and subsequently melt mixing in a mixer, or by mixing the polymers together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder.

The polymers and components of the present disclosure can be blended by any suitable means, and are typically blended to yield an intimately mixed composition which may be a homogeneous, single phase mixture. For example, they may be blended in a static mixer, batch mixer, extruder, or a combination thereof, that is sufficient to achieve an adequate dispersion of the components of the composition.

Mixing may involve first dry blending using, for example, a tumble blender, where the polymers (and optional additive) are brought into contact first, without intimate mixing, which may then be followed by melt blending in an extruder. Another method of blending the components is to melt blend the first polymer as a pellet and the second polymer as a pellet directly in an extruder or batch mixer. Mixing can also involve a “master batch” approach, where the final modifier concentration is achieved by combining a neat polymer with an appropriate amount of modified polymer that had been previously prepared at a higher additive concentration. The mixing may take place as part of a processing method used to fabricate articles, such as in the extruder on an injection molding machine or blown-film line or fiber line.

In at least one embodiment of the present disclosure, component A (polypropylene), component B (copolymer), and/or optional additional polymers, and the optional additional additive(s) may be “melt blended” in an apparatus such as an extruder (single or twin screw) or batch mixer or may be “dry blended” with one another using a tumbler, double-cone blender, ribbon blender, or other suitable blender. In yet another embodiment, the polymers and the optional additional additive(s) are blended by a combination of approaches, for example a tumbler followed by an extruder. A suitable method of blending is to include the final stage of blending as part of an article fabrication step, such as in the extruder used to melt and convey the composition for a molding step like injection molding or blow molding. Melt blending may include direct injection of one or more polymer and/or elastomer into the extruder, either before or after a different one or more polymer and/or elastomer is fully melted. Extrusion technology for polymers is described in more detail in, for example, PLASTICS EXTRUSION TECHNOLOGY p. 26-37 (Friedhelm Hensen, ed. Hanser Publishers 1988).

In another aspect of the present disclosure, the polymers and the optional additional additive(s) may be blended in solution by any suitable means by using a solvent that dissolves the components of the composition to a suitable extent. The blending may occur at a temperature or pressure where the components remain in solution. Suitable conditions include blending at high temperatures, such as 10° C. or more, such as 20° C. or more over the melting point of one or more polymer and/or elastomer. Such solution blending may be useful in processes where one or more polymer and/or elastomer is made by solution process and a modifier is added directly to the finishing train, rather than added to the dry polymer, polymer and/or elastomer in another blending step altogether. Such solution blending may also be useful in processes where one or more polymer and/or elastomer is made in a bulk or high pressure process where one or more polymer and/or elastomer and the modifier are in soluble in the monomer (as solvent). As with the solution process, one or more polymer and/or elastomer can be added directly to the finishing train rather than added to the dry one or more polymer and/or elastomer in another blending step altogether.

Accordingly, in the cases of fabrication of products using methods that involve an extruder, such as injection molding, blow molding, blown film, cast, coating, and compounding, any suitable means of combining the one or more components of the composition to achieve the desired composition serve equally well as fully formulated pre-blended pellets, since the forming process can include a re-melting and mixing of the raw material; example combinations include simple blends of neat polymer and/or elastomer pellets (and optional additive(s)), neat polymer and/or elastomer granules, and neat polymer and/or elastomer pellets and pre-blended pellets. However, little mixing of the melt components occurs in the process of compression molding, and the use of pre-blended pellets would be better than the use of simple blends of the constituent pellets.

In another embodiment, a composition of the present disclosure is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

The blends may be produced by mixing the polymers and/or elastomers of the present disclosure with one or more polymers (e.g., as described above), by connecting reactors together in series to make reactor blends or by using more than one catalyst in the same reactor to produce multiple species of polymer. The polymers can be mixed together prior to being put into the extruder or may be mixed in an extruder.

The heterogeneous polymer/elastomer blends described may be formed into desirable end use products by any suitable means. The heterogeneous polymer/elastomer blends may be useful for making articles by blow molding, extrusion, injection molding, thermoforming, gas foaming, elasto-welding and compression molding techniques.

Blow molding forming, for example, includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, CONCISE ENCYCLOPEDIA OF POLYMER SCIENCE AND ENGINEERING 90-92 (Jacqueline I. Kroschwitz, ed., John Wiley & Sons 1990).

In at least one embodiment of the formation and shaping process, profile co-extrusion can be used. The profile co-extrusion process parameters are as above for the blow molding process, except the die temperatures (dual zone top and bottom) can be from 150° C. to 235° C., the feed blocks are from 90° C. to 250° C., and the water cooling tank temperatures are from 10° C. to 40° C.

One embodiment of an injection molding process is described as follows. The shaped laminate is placed into the injection molding tool. The mold is closed and the substrate material is injected into the mold. The substrate material has a melt temperature from about 200° C. to about 300° C., such as from about 215° C. to about 250° C. and is injected into the mold at an injection speed of from 2 to 10 seconds. After injection, the material is packed or held at a predetermined time and pressure to make the part dimensionally and aesthetically correct. Typical time periods are from 5 to 25 seconds and pressures from 1,380 kPa to 10,400 kPa. The mold is cooled to from about 10° C. to about 70° C. to cool the substrate. The temperature will depend on the desired gloss and appearance desired. Typical cooling time is from 10 to 30 seconds, depending in part on the thickness. Finally, the mold is opened and the shaped composite article ejected. Likewise, molded articles may be fabricated by injecting molten polymer into a mold that shapes and solidifies the molten polymer into a desirable geometry and thickness of molded articles. Sheet may be made either by extruding a substantially flat profile from a die, onto a chill roll, or alternatively by calendaring. Sheets typically have a thickness of from 10 mils to 100 mils (254 m to 2540 m), although a sheet may be substantially thicker. Tubing or pipe may be obtained by profile extrusion for uses in medical, potable water, land drainage applications or the like. The profile extrusion process involves the extrusion of molten polymer through a die. The extruded tubing or pipe is then solidified by chill water or cooling air into a continuous extruded article. Sheet made from a composition of the present disclosure may be used to form a container. Such containers may be formed by thermoforming, solid phase pressure forming, stamping and other shaping techniques. Sheets may also be formed to cover floors or walls or other surfaces.

In an embodiment of the thermoforming process, the oven temperature is from about 160° C. to about 195° C., the time in the oven from about 10 seconds to about 20 seconds, and the die temperature, typically a male die, from about 10° C. to about 71° C.

In an embodiment of the injection molding process, where a substrate material is injection molded into a tool including the shaped laminate, the melt temperature of the substrate material is from about 225° C. to about 255° C., or from about 230° C. to about 250° C., the fill time is from about 2 to about 10 seconds, or from about 2 to about 8 seconds, and a tool temperature of from about 25° C. to about 65° C., or from about 27° C. to about 60° C. In at least one embodiment, the substrate material is at a temperature that is hot enough to melt a tie-layer material or backing layer to achieve adhesion between the layers.

In yet another embodiment of the present disclosure, the compositions are secured to a substrate material using a blow molding operation. Blow molding may be useful in such applications as for making closed articles such as fuel tanks and other fluid containers, playground equipment, outdoor furniture and small enclosed structures. In at least one embodiment, a composition of the present disclosure is extruded through a multi-layer head, followed by placement of the uncooled laminate into a parison in the mold. The mold, with either male or female patterns inside, is then closed and air is blown into the mold to form the part. The steps outlined above may be varied, depending upon the desired result. For example, an extruded sheet formed from a composition of the present disclosure may be directly thermoformed or blow molded without cooling, thus skipping a cooling step. Other parameters may be varied as well in order to achieve a finished composite article having desirable features.

In at least one embodiment, a composition of the present disclosure is formed into an article such as a weather seal, a hose, a belt, a gasket, a molding, boots, an elastic fiber and like articles. Foamed end-use articles are also envisioned. More specifically, the blends of the present disclosure can be formed as part of a vehicle part, such as a weather seal, a brake part including, cups, coupling disks, diaphragm cups, boots such as constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal, or plastic combination materials. Also contemplated are transmission belts including V-belts, toothed belts with truncated ribs containing fabric faced V's, ground short fiber reinforced Vs or molded gum with short fiber flocked V's. The cross section of such belts and their number of ribs may vary with the final use of the belt, the type of market and the power to transmit. They also can be flat made of textile fabric reinforcement with frictioned outside faces. Vehicles contemplated where these parts will find application include, but are not limited to passenger autos, motorcycles, trucks, boats and other vehicular conveyances.

### Stretch Films

Compositions of the present disclosure may be utilized to prepare stretch films. Stretch films can be used in a variety of bundling and packaging applications. The term “stretch film” indicates films capable of stretching and applying a bundling force, and includes films stretched at the time of application as well as “pre-stretched” films, i.e., films which are provided in a pre-stretched form for use without additional stretching. Stretch films can be monolayer films or multilayer films, and can include additives, such as cling-enhancing additives such as tackifiers, and non-cling or slip additives, to tailor the slip/cling properties of the film.

### Shrink Films

Compositions of the present disclosure may be utilized to prepare shrink films. Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction or in both longitudinal and transverse directions. Shrink films are described, for example, in WO 2004/022646.

Industrial shrink films can be used for bundling articles on pallets. Typical industrial shrink films are formed in a single bubble blown extrusion process to a thickness of about 80 to 200 μm, and provide shrinkage in two directions, typically at a machine direction (MD) to transverse direction (TD) ratio of about 60:40.

Retail films can be used for packaging and/or bundling articles for consumer use, such as, for example, in supermarket goods. Such films are typically formed in a single bubble blown extrusion process to a thickness of about 35 μm to 80 μm, with a typical MD:TD shrink ratio of about 80:20.

Films may be used in “shrink-on-shrink” applications. “Shrink-on-shrink,” refers to the process of applying an outer shrink wrap layer around one or more items that have already been individually shrink wrapped (the “inner layer” of wrapping). In these processes, it is desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer. Some films described have been observed to have a sharp shrinking point when subjected to heat from a heat gun at a high heat setting, which indicates that they may be especially suited for use as the inner layer in a variety of shrink-on-shrink applications.

### Greenhouse Films

Compositions of the present disclosure may be utilized to prepare stretch to prepare greenhouse films. Greenhouse films are typically heat retention films that, depending on climate requirements, retain different amounts of heat. Less demanding heat retention films are used in warmer regions or for spring time applications. More demanding heat retention films are used in the winter months and in colder regions.

### Bags

Compositions of the present disclosure may be utilized to prepare bags. Bags include those bag structures and bag applications used in consumer goods and industrial applications. Exemplary bags include shipping sacks, trash bags and liners, industrial liners, produce bags, and heavy duty bags.

### Packaging

Compositions of the present disclosure may be utilized to prepare packaging. Packaging includes those packaging structures and packaging applications used in consumer goods and industrial applications. Exemplary packaging includes flexible packaging, food packaging, e.g., fresh cut produce packaging, frozen food packaging, bundling, packaging and unitizing a variety of products. Applications for such packaging include various foodstuffs, rolls of carpet, liquid containers, and various like goods normally containerized and/or palletized for shipping, storage, and/or display.

### Blow Molded Articles

Compositions of the present disclosure may be used in suitable blow molding processes and applications. Such processes involve a process of inflating a hot, hollow thermoplastic preform (or parison) inside a closed mold. In this manner, the shape of the parison conforms to that of the mold cavity, enabling the production of a wide variety of hollow parts and containers.

In a typical blow molding process, a parison is formed between mold halves and the mold is closed around the parison, sealing one end of the parison and closing the parison around a mandrel at the other end. Air is then blown through the mandrel (or through a needle) to inflate the parison inside the mold. The mold is then cooled and the part formed inside the mold is solidified. Finally, the mold is opened and the molded part is ejected. The process can be performed to provide any suitable design having a hollow shape, including bottles, tanks, toys, household goods, automobile parts, and other hollow containers and/or parts.

Blow molding processes may include extrusion and/or injection blow molding, as described above. Extrusion blow molding is typically suited for the formation of items having a comparatively heavy weight, such as greater than about 12 ounces, including food, laundry, or waste containers. Injection blow molding is typically used to achieve accurate and uniform wall thickness, high quality neck finish, and to process polymers that cannot be extruded. Typical injection blow molding applications include, but are not limited to, pharmaceutical, cosmetic, and single serving containers, typically weighing less than 12 ounces.

### Injection Molded Articles

Compositions of the present disclosure may also be used in injection molded applications. Injection molding is a process that usually occurs in a cyclical fashion. Cycle times may be from 10 to 100 seconds and are controlled by the cooling time of the polymer or polymer blend used.

In a typical injection molding cycle, polymer pellets or powder are fed from a hopper and melted in a reciprocating screw type injection molding machine. The screw in the machine rotates forward, filling a mold with melt and holding the melt under high pressure. As the melt cools in the mold and contracts, the machine adds more melt to the mold to compensate. Once the mold is filled, the mold is isolated from the injection unit and the melt cools and solidifies. The solidified part is ejected from the mold and the mold is then closed to prepare for the next injection of melt from the injection unit.

Injection molding processes offer high production rates, good repeatability, minimum scrap losses, and little to no need for finishing of parts. Injection molding is suitable for a wide variety of applications, including containers, household goods, automobile components, electronic parts, and many other solid articles.

### Extrusion Coating

Compositions of the present disclosure may be used in extrusion coating processes and applications. Extrusion coating is a plastic fabrication process in which molten polymer is extruded and applied onto a non-plastic support or substrate, such as paper or aluminum in order to obtain a multi-material complex structure. The complex structure typically combines toughness, sealing and resistance properties of the polymer formulation with barrier, stiffness or aesthetic attributes of the non-polymer substrate. In such processes, the substrate is typically fed from a roll into a molten polymer as the polymer is extruded from a slot die, which is similar to a cast film process. The resultant structure is cooled, typically with a chill roll or rolls, and formed into finished rolls.

Extrusion coating materials can be used in, for example, food and non-food packaging, pharmaceutical packaging, and manufacturing of goods for the construction (insulation elements) and photographic industries (paper).

### Foamed Articles

Compositions of the present disclosure may be used in foamed applications. In an extrusion foaming process, a blowing agent, such as, for example, carbon dioxide, nitrogen, or a compound that decomposes to form carbon dioxide or nitrogen, is injected into a polymer melt by means of a metering unit. The blowing agent is then dissolved in the polymer in an extruder, and pressure is maintained throughout the extruder. A rapid pressure drop rate upon exiting the extruder creates a foamed polymer having a homogenous cell structure. The resulting foamed product is typically light, strong, and suitable for use in a wide range of applications in industries such as packaging, automotive, aerospace, transportation, electric and electronics, and manufacturing.

### Wire and Cable Applications

Also provided are electrical articles and devices including one or more layers formed of or including composition(s) of the present disclosure. Such devices include, for example, electronic cables, computer and computer-related equipment, marine cables, power cables, telecommunications cables or data transmission cables, and combined power/telecommunications cables.

Electrical devices can be formed by any suitable methods, such as by one or more extrusion coating steps in a reactor/extruder equipped with a cable die. In a typical extrusion method, an optionally heated conducting core is pulled through a heated extrusion die, typically a cross-head die, in which a layer of melted polymer composition is applied. Multiple layers can be applied by consecutive extrusion steps in which additional layers are added, or, with the proper type of die, multiple layers can be added simultaneously. The cable can be placed in a moisture curing environment, or allowed to cure under ambient conditions.

### Rotomolded Products

Also provided are rotomolded products including one or more layers formed of or including composition(s) of the present disclosure. Rotomolding or rotational molding involves adding an amount of material to a mold, heating and slowly rotating the mold so that the softened material coats the walls of the mold. The mold continues to rotate at all times during the heating phase, thus maintaining even thickness throughout the part and preventing deformation during the cooling phase. Examples of rotomolded products include but are not limited to furniture, toys, tanks, road signs tornado shelters, containers including United Nations-approved containers for the transportation of nuclear fissile materials.

### Embodiments of the Present Disclosure

Clause 1. A thermoplastic vulcanizate including:
a polypropylene; and
a copolymer including an ethylene content, a propylene content, and an α,ω-diene content, where the copolymer is crosslinked;
the thermoplastic vulcanizate having a shore hardness of about 20 Shore A or greater.

Clause 2. The thermoplastic vulcanizate of clause 1, further including one or more fillers selected from the group consisting of: calcium carbonate, clay, silica, talc, titanium dioxide, carbon black, organic and inorganic nanoscopic fillers, and combination(s) thereof.

Clause 3. The thermoplastic vulcanizate of any of clauses 1 to 2, further including a plasticizer or oil.

Clause 4. The thermoplastic vulcanizate of the clause 3, where the plasticizer or oil includes a mineral oil, a synthetic oil, an ester plasticizer or a combination thereof.

Clause 5. The thermoplastic vulcanizate of clause 4, where the mineral oil includes an aromatic oil, a naphthenic oil, a paraffinic oil, an isoparaffinic oil, a synthetic oil, or any combination thereof.

Clause 6. The thermoplastic vulcanizate of any of clauses 1 to 5, further including a curing system.

Clause 7. The thermoplastic vulcanizate clause 6, where the curing system includes hydrosilylation curatives.

Clause 8. The thermoplastic vulcanizate of clause 6, where the curing system includes a phenolic resin and a cure accelerator.

Clause 9. The thermoplastic vulcanizate of clause 8, where the cure accelerator is stannous chloride.

Clause 10. The thermoplastic vulcanizate of clause 6, where the curing system includes peroxide.

Clause 11. The thermoplastic vulcanizate of clause 6, where the curing system is a silane grafting and moisture curing system.

Clause 12. The thermoplastic vulcanizate of any of clauses 1 to 11, where the thermoplastic vulcanizate has a Young's modulus of about 1100 MPa or greater.

Clause 13. The thermoplastic vulcanizate of any of clauses 1 to 12, where the thermoplastic vulcanizate has a tensile strength at yield of about 18 MPa or greater.

Clause 14. The thermoplastic vulcanizate of any of clauses 1 to 13, where the thermoplastic vulcanizate has an elongation at yield of about 6% or less.

Clause 15. The thermoplastic vulcanizate of any of clauses 1 to 14, where the thermoplastic vulcanizate has a tensile strength at break of about 17 MPa or greater.

Clause 16. The thermoplastic vulcanizate of any of clauses 1 to 15, where the thermoplastic vulcanizate has a tension set of about 9% or less.

Clause 17. The thermoplastic vulcanizate of any of clauses 1 to 16, where the thermoplastic vulcanizate has an oil swell of about 15% weight gain or less.

Clause 18. The thermoplastic vulcanizate of any of clauses 1 to 17, where the thermoplastic vulcanizate copolymer has an α,ω-diene content of about 1 wt % to about 10 wt %.

Clause 19. The thermoplastic vulcanizate of any of clauses 1 to 18, where the thermoplastic vulcanizate further includes particles of the copolymer dispersed in the polypropylene and about 75% of the particles have an average diameter of about 5 μm or less.

Clause 20. The thermoplastic vulcanizate of any of clauses 1 to 19, where the thermoplastic vulcanizate has a melt flow rate of about 5 g/10 min to about 200 g/10 min.

Clause 21. A thermoplastic vulcanizate including:
a polypropylene; and
an elastomeric polymer;

the thermoplastic vulcanizate having:
a shore hardness of about 40 Shore D or greater;
a tensile strength at yield of about 18 MPa or greater; and an oil swell of about 15% weight gain or less.

Clause 22. The thermoplastic vulcanizate of clause 21, where the thermoplastic vulcanizate has a shore hardness of about 45 Shore D or greater.

Clause 23. The thermoplastic vulcanizate of any of clauses 21 to 22, where the thermoplastic vulcanizate has a tensile strength at yield of about 20 MPa or greater.

Clause 24. The thermoplastic vulcanizate of any of clauses 21 to 23, where the thermoplastic vulcanizate has an elongation at yield of about 6% or less.

Clause 25. The thermoplastic vulcanizate of any of clauses 21 to 24, where the thermoplastic vulcanizate has a tensile strength at break of about 20 MPa or greater.

Clause 26. The thermoplastic vulcanizate of any of clauses 21 to 25, where the thermoplastic vulcanizate has a tension set of about 9% or less.

Clause 27. The thermoplastic vulcanizate of any of clauses 21 to 26, where the thermoplastic vulcanizate has an oil swell of about 10% weight gain or less.

Clause 28. The thermoplastic vulcanizate of any of clauses 21 to 27, where the elastomeric polymer has an α,ω-diene content of about 1 wt % to about 10 wt %.

Clause 29. A process for producing a thermoplastic vulcanizate, the process including:
introducing a catalyst and propylene to a first reactor to form a first polymer;
introducing the first polymer, ethylene, at least one α,ω-diene, and optionally additional propylene to a second reactor to form an impact copolymer; and
crosslinking the impact copolymer.

Clause 30. The process of clause 29, where the α,ω-diene is selected from the group consisting of 1,5-hexadiene, 1,6-heptadiene, 1,7-octadiene, 1,8-nondiene, 1,9-decadiene, 1,10-undecadiene, 1,11-dodecadiene, 1,12-tridecadiene, 1,13-tetradecadiene, 1,14-pentadecadiene, 1,15-hexadecadiene, and combination(s) thereof.

Clause 31. The process of any of clauses 29 to 30, further including introducing hydrogen to the first reactor.

Clause 32. The process of any of clauses 29 to 31, further including removing hydrogen before introducing the first polymer to the second reactor.

Clause 33. The process of any of clauses 29 to 32, where the first polymer has a vinyl content of about 0.05 or greater.

Clause 34. The process of any of clauses 29 to 33, where the crosslinking further includes introducing a curing agent to form a curing composition.

Clause 35. The process of clause 34, where the crosslinking further includes exposing the curing composition to a temperature of about 160° C. or greater.

Clause 36. The process of any of clauses 34 to 35, where the crosslinking further includes exposing the curing composition to vulcanization concurrently with mixing or extruding.

Clause 37. The process of any of clauses 34 to 36, where the curing agent is selected from the group consisting of a silicon hydride, a phenolic resin, a peroxide, a maleimide, a free radical initiator, sulfur, zinc metal compounds, and combination(s) thereof.

Clause 38. The process of clause 37, where the curing composition further includes a co-agent selected from the group consisting of zinc oxide, stannous chloride, and a combination thereof.

Clause 39. The process of any of clauses 29 to 38, where the first polymer has a density of from about 0.90 g/cm³ to about 0.91 g/cm³ and an melt flow rate of from about 0.1 g/10 min to about 600 g/10 min.

Clause 40. A process for producing a thermoplastic vulcanizate, the process including:
introducing a catalyst and propylene to a first reactor to form a first polymer;
introducing the first polymer, ethylene, at least one α,ω-diene, and optionally additional propylene to a second reactor to form an impact copolymer;
introducing the impact copolymer into a blender; and
dynamically vulcanizing at least a portion of the contents of the blender so as to form a thermoplastic vulcanizate.

Clause 41. The process of clause 40, where the blender is selected from the group consisting of a mixer, a mill, and an extruder.

Clause 42. The process of any of clauses 40 to 41, where the extrusion temperature is from about 160° C. to about 240° C.

Clause 43. The process of any of clauses 40 to 42, where a plasticizer is introduced into the blender after at least partial dynamic vulcanization.

Clause 44. The process of any of clauses 40 to 43, where a plasticizer is introduced into the blender before at least partial dynamic vulcanization.

Clause 45. An article of manufacture including the thermoplastic vulcanizate of clause 1 to 28.

Clause 46. An article of manufacture formed by the process of any of clauses 29 to 44.

Clause 47. The article of clauses 45 or 46, where the article is selected from the group consisting of glass run channel weatherseals, corner moldings, seals, gaskets, flexible pipe for petroleum application, and thermoplastic composite pipe.

### Examples

### General

### Dynamic Mechanical Analysis (DMA)

The glass transition temperature (Tg) is measured using dynamic mechanical analysis. A dynamic mechanical analysis test provides information about the small-strain mechanical response of a sample as a function of temperature over a temperature range that includes the glass transition region and the visco-elastic region prior to melting. Specimens are tested using a commercially available DMA instrument (e.g., TA Instruments DMA 2980 or Rheometrics RSA) equipped with a dual cantilever test fixture. The specimen is cooled to −130° C. then heated to 60° C. at a heating rate of 2° C./min while subjecting to an oscillatory deformation at 0.1% strain and a frequency of 1 rad/sec. The output of these DMA experiments is the storage modulus (E′) and loss modulus (E″). The storage modulus measures the elastic response or the ability of the material to store energy, and the loss modulus measures the viscous response or the ability of the material to dissipate energy. The ratio of E″/E′, called Tan-delta, gives a measure of the damping ability of the material; peaks in Tan-delta are associated with relaxation modes for the material. Tg is defined to be the peak temperature associated with the β-relaxation mode, which typically occurs from about −80° C. to about 20° C. for polyolefins. In a hetero-phase blend, separate β-relaxation modes for each blend component can cause more than one Tg to be detected for the blend; assignment of the Tg for each component may be based on the Tg observed when the individual components are similarly analyzed by DMA (although slight temperature shifts are possible).

### Differential Scanning Calorimetry (DSC)

Crystallization temperature (Tc) and melting temperature (or melting point, Tm) are measured using Differential Scanning Calorimetry (DSC) on a commercially available instrument (e.g., TA Instruments 2920 DSC). Typically, 6 to 10 mg of molded polymer or plasticized polymer are sealed in an aluminum pan and loaded into the instrument at room temperature. Melting data (first heat) is acquired by heating the sample to at least 30° C. above its melting temperature, typically 220° C. for polypropylene, at a heating rate of 10° C./min. The sample is held for at least 5 minutes at this temperature to destroy its thermal history. Crystallization data are acquired by cooling the sample from the melt to at least 50° C. below the crystallization temperature, typically −50° C. for polypropylene, at a cooling rate of 20° C./min. The sample is held at this temperature for at least 5 minutes, and finally heated at 10° C./min to acquire additional melting data (second heat). The endothermic melting transition (first and second heat) and exothermic crystallization transition are analyzed according to standard procedures. The melting temperatures reported are the peak melting temperatures from the second heat unless otherwise specified.

For polymers displaying multiple peaks, the melting temperature is defined to be the peak melting temperature from the melting trace associated with the largest endothermic calorimetric response (as opposed to the peak occurring at the highest temperature). Likewise, the crystallization temperature is defined to be the peak crystallization temperature from the crystallization trace associated with the largest exothermic calorimetric response (as opposed to the peak occurring at the highest temperature).

Areas under the DSC curve are used to determine the heat of transition (heat of fusion, Hf, upon melting or heat of crystallization, Hc, upon crystallization), which can be used to calculate the degree of crystallinity (also called the percent crystallinity). The percent crystallinity (X %) is calculated using the formula: [area under the curve (in J/g)/H° (in J/g)]*100, where H° is the ideal heat of fusion for a perfect crystal of the homopolymer of the major monomer component. These values for H° are to be obtained from the Polymer Handbook, Fourth Edition, published by John Wiley and Sons, New York 1999, except that a value of 290 J/g is used for H° (polyethylene), a value of 140 J/g is used for H° (polybutene), and a value of 207 J/g is used for H° (polypropylene).

### Size-Exclusion Chromatography (SEC)

Molecular weight (weight-average molecular weight, Mw, number-average molecular weight, Mn, and molecular weight distribution, Mw/Mn or PDI) are determined using a commercial High Temperature Size Exclusion Chromatograph (e.g., from Waters Corporation or Polymer Laboratories) equipped with three in-line detectors: a differential refractive index detector (DRI), a light scattering (LS) detector, and a viscometer.

The following approach is used for polyolefins. Details not described, including detector calibration, can be found in Macromolecules 34, pp. 6812-6820 (2001). Column set: 3 Polymer Laboratories PLgel 10 mm Mixed-B columns; Flow rate: 0.5 mL/min; Injection volume: 300 μL; Solvent: 1,2,4-trichlorobenzene (TCB), containing 6 g of butylated hydroxy toluene dissolved in 4 liters of Aldrich reagent grade TCB

The various transfer lines, columns, DRI detector and viscometer are contained in an oven maintained at 135° C. The TCB solvent is filtered through a 0.7 μm glass pre-filter and subsequently through a 0.1 μm Teflon filter, then degassed with an online degasser before entering the SEC. Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/mL at room temperature and 1.324 g/mL at 135° C. Injection concentrations may include about 1 mg/mL to about 2 mg/mL, with lower concentrations being used for higher molecular weight samples. Prior to running a set of samples, the DRI detector and injector are purged, the flow rate increased to 0.5 m/min, and the DRI allowed to stabilize for 8-9 hours; the LS laser is turned on 1 hr before running samples.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and (dn/dc) is the same as described below for the light scattering (LS) analysis. The refractive index, n=1.500 for TCB at 135° C. and λ=690 nm. For purposes of this disclosure (dn/dc)=0.104 for propylene polymers and ethylene polymers, and 0.1 otherwise.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{α}} ,$$

where Mᵥ is the viscosity-average molecular weight based on molecular weights determined by LS analysis and the, K and α are for the reference linear polymer, which are, for purposes of this disclosure, α=0.700 and K=0.0003931 for ethylene, propylene, diene monomer copolymers, OR [α=0.695+(0.01*(wt. fraction propylene)) and K=0.000579−(0.0003502*(wt. fraction propylene)) for ethylene-propylene copolymers and ethylene-propylene-diene terpolymers], α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer. Concentrations are expressed in g/cm³ molecular weight is expressed in g/mole, and intrinsic viscosity (hence K in the Mark-Houwink equation) is expressed in dL/g unless otherwise noted. Calculation of the w2b values is as discussed above.

In at least one embodiment the polymer produced has a composition distribution breadth index (CDBI) of 50% or more, such as 60% or more, such as 70% or more. CDBI is a measure of the composition distribution of monomer within the polymer chains and is measured by the procedure described in PCT publication WO 93/03093, published Feb. 18, 1993, specifically columns 7 and 8 as well as in Wild et al, J. Poly. Sci., Poly. Phys. Ed., Vol. 20, p. 441 (1982) and U.S. Pat. No. 5,008,204, including that fractions having a weight average molecular weight (Mw) below 15,000 g/mol are ignored when determining CDBI.

Ethylene content in ethylene copolymers is determined by ASTM D 5017-96, except that the minimum signal-to-noise should be 10,000:1. Propylene content in propylene copolymers is determined by following the approach of Method 1 in Di Martino and Kelchermans, J. Appl. Polym. Sci. 56, p. 1781 (1995), and using peak assignments from Zhang, Polymer 45, p. 2651 (2004) for higher olefin comonomers.

Procedures for measuring the total pore volume of a porous support are discussed in Volume 1, Experimental Methods in Catalytic Research (Academic Press, 1968) (specifically see pages 67-96). This procedure involves the use of a classical BET apparatus for nitrogen absorption. Another method is described in Innes, Total Porosity and Particle Density of Fluid Catalysts By Liquid Titration, Vol. 28, No. 3, Analytical Chemistry 332-334 (March, 1956). Another method is described in ASTM D4284. For purposes of this disclosure, in the event of conflict between the three, Volume 1, Experimental Methods in Catalytic Research (Academic Press, 1968) (specifically see pages 67-96) shall be used. The weight average particle size is measured by determining the weight of material collected on a series of U.S. Standard sieves and determining the weight average particle size in micrometers based on the sieve series used.

### Melt Flow Rate of Polymers and Blends

Melt Flow Rate (MFR) is measured according to ASTM D1238 at 230° C. under a load of 2.16 kg. Melt Index (MI) is measured according to ASTM D 1238 at 190° C. under a load of 2.16 kg. The units are g/10 min.

### Polymer Density

Density is measured by density-gradient column, such as described in ASTM D1505, on a compression-molded specimen that has been slowly cooled to room temperature.

### Mechanical Properties

Test specimens for mechanical property testing were injection-molded, unless otherwise specified. The testing temperature was standard laboratory temperature (23±2° C.) as specified in ASTM D618, unless otherwise specified. Instron load frames were used for tensile and flexure testing.

Tensile properties were determined according to ASTM D638, including Young's modulus (also called modulus of elasticity), yield stress (also called tensile strength at yield), yield strain (also called elongation at yield), break stress (also called tensile strength at break), and break strain (also called elongation at break). The energy to yield is defined as the area under the stress-strain curve from zero strain to the yield strain. The energy to break is defined as the area under the stress-strain from zero strain to the break strain. Injection-molded tensile bars were of either ASTM D638 Type I or Type IV geometry, tested at a speed of 2 inch/min. Compression-molded tensile bars were of ASTM D412 Type C geometry, tested at a speed of 20 inch/min. For compression-molded specimens only: the yield stress and yield strain were determined as the 10% offset values as defined in ASTM D638. Break properties were reported only if a majority of test specimens broke before a strain of about 2000%, which is the maximum strain possible on the load frame used for testing.

Flexure properties were determined according to ASTM D790A, including the 1% secant modulus and 2% secant modulus. Test specimen geometry was as specified under “Molding Materials (Thermoplastics and Thermosets)”, and the support span was 2 inches.

Heat deflection temperature was determined according to ASTM D648, at 66 psi, on injection-molded specimens.

### Impact Properties

Gardner impact strength was determined according to ASTM D5420, on 0.125 inch thick injection-molded disks, at the specified temperature.

Notched Izod impact resistance was determined according to ASTM D256, at the specified temperature. A TMI Izod Impact Tester was used. Specimens were either cut individually from the center portion of injection-molded ASTM D638 Type I tensile bars, or pairs of specimens were made by cutting injection-molded ASTM D790 “Molding Materials (Thermoplastics and Thermosets)” bars in half. The notch was oriented such that the impact occurred on the notched side of the specimen (following Procedure A of ASTM D256) in most cases; where specified, the notch orientation was reversed (following Procedure E of ASTM D256). All specimens were assigned a thickness of 0.122 inch for calculation of the impact resistance. All breaks were complete, unless specified otherwise.

### Fabric and Film Properties

Flexure and tensile properties (including 1% Secant Flexure Modulus, Peak Load, Tensile Strength at Break, and Elongation at Break) are determined by ASTM D 882. Elmendorf tear is determined by ASTM D 1922. Puncture and puncture energy are determined by ASTM D 3420. Total energy dart impact is determined by ASTM D 4272

### Fluid Properties

The number-average molecular weight (Mn) can be determined by Gel Permeation Chromatography (GPC), as described in “Modem Size Exclusion Liquid Chromatographs”, W. W. Yan, J. J. Kirkland, and D. D. Bly, J. Wiley & Sons (1979); or estimated by ASTM D 2502; or estimated by freezing point depression, as described in “Lange's Handbook of Chemistry”, 15th Edition, McGrawHill. The average carbon number (Cn) is calculated from Mn by Cn=(Mn−2)/14.

### Experimental Detail of Polymerization Reactions

Impact copolymers without hydrogen in the second stage were synthesized as follows. During first stage polymerization, to a 2 L ZipperClave reactor was introduced 0.8 mmol TEAL, 0.08 mmol donor and 250 mmol hydrogen. 0.08 mmol TEAL, 0.08 mmol donor and 6 mg commercial Toho THC-133 Ziegler-Natta catalyst precontacted in a charge tube were flushed into the reactor with 1250 mL propylene. The A-donor is a mixture of 5 mol % dicyclopentyldimethoxysilane and 95 mol % n-propyltriethoxysilane, and the B-donor is diethylaminotriethoxysilane. The agitation was started. The reaction mixture was heated up from room temperature to 70° C. and the polymerization reaction was carried out for 1 hr. At the end of propylene homopolymerization, volatiles were vented off. During second stage polymerization, 40/60 molar ethylene and propylene gases were added to reach 180 psig total pressure and the reaction mixture was allowed to agitate for 0.5 hr at 70° C. In some examples diene was added, including 1,9-decadiene or 1,7-octadiene. ICPs synthesized according to the above method are included in Table 1. In all ICP examples of Table 1, A-donor was used. The homopolymer PP matrix MFR of all ICPs listed in Table 1 (A-F) was about 171 g/10 min (230° C., 2.16 kg, ASTM-1238).

TABLE 1
Characteristics of ICPs used to make TPVs

| | | Diene | ICP | | | | |
|---|---|---|---|---|---|---|---|
| ICP | | amount | MFR | C2 | | IV | |
| No. | α,ω-diene | (ml) | (g/10 min) | % | R % | ratio | Mw/Mn |
| A | 1,9- | 2 | 11.75 | 23.28 | 46.8 | 11.45 | 14.98 |
| | decadiene | | | | | | |
| B | 1,9- | 6 | 2.91 | 24.87 | 45.4 | 35.16 | 12.41 |
| | decadiene | | | | | | |
| C | 1,7- | 2 | 9.36 | 19.01 | 48.4 | 27.13 | 10.71 |
| | octadiene | | | | | | |
| D | 1,7- | 6 | 9.8 | 16.04 | 53.6 | 49 | 10.7 |
| | octadiene | | | | | | |
| E | 1,7- | 2 | 21.4 | 18.2 | — | — | — |
| | octadiene | | | | | | |
| F | 1,7- | 4 | 13.8 | 19.3 | — | — | — |
| | octadiene | | | | | | |

The ICPs formed were crosslinked via a dynamic vulcanization process. Specifically, thermoplastic vulcanizates were prepared in a laboratory Brabender-Plasticorder (model EPL-V5502). The mixing bowl had a capacity of 85 ml with the cam-type rotors employed. In Ex. 1, 57.67 grams of the ICP composition D (containing both polypropylene plastic and EPR rubber phases) and 0.22 grams of ZnO were initially added to the mixing bowl that was heated to 180° C. at 100 rpm rotor speed and allowed to melt for about 5 minutes. When mixer torque had levelled (at typically within the period of 5 minutes), 0.44 gr of Xiameter OFX-5084 (silicon hydride functional alkyl silicone fluid used for hydrosilylation crosslinking reactions, Dow Chemical) was added dropwise to the melt mix. When torque recovered at about 30 seconds later after addition of Xiameter OFX-5084, 5.03 gr of a solution of active platinum catalyst with a cyclovinylsiloxane ligand obtained under the tradename PCO85™ (UCT Specialties) in oil was added in the mixing bowl and reaction allowed to take place for about 5 minutes. The solution of the platinum catalyst contained 0.00595 parts by weight of PC085 in 2.5 parts by weight of Group II paraffinic oil Paramount 6001R (Chevron Phillips). Subsequently, 10.24 grams of an AG slurry was added in the mixture and allowed to mix for about 2 min after which mixing stopped. The AG slurry contained 556 parts by weight of Group II paraffinic oil Paramount 6001R (Chevron Phillips), 68.1 parts by weight of calcium stearate and 34 parts by weight of Irganox B4329.

TPV compositions of Examples 2, 3, 5, and 7 were made with the same procedure as described for Ex. 1 using the formulations shown in Table 2. The compositions of Ex. 4 and 6 were made with the same procedure as described for Ex. 1 using the formulations of Table 2 without the addition of ZnO, Xiameter OFX-5084, and solution of PCO85™ platinum catalyst. The example TPV compositions are summarized in Table 2.

TABLE 2
Example TPV Compositions

| Composition | Ex. 1 | Ex. 2 | Ex. 3 | Ex. 4 | Ex. 5 | Ex. 6 | Ex. 7 |
|---|---|---|---|---|---|---|---|
| PP7143KNE1 | | | | | | | |
| PP7033E2 | | | | | | | |
| D | 526 | | | | | | |
| A | | 526 | | | | | |
| B | | | 526 | | | | |
| F | | | | 526 | 526 | | |
| E | | | | | | 526 | 526 |
| Xiameter OFX-5084 | 4 | 4 | 4 | | 4 | | 4 |
| PC085 (slurry in oil) | 5 | 5 | 5 | | 5 | | 5 |
| AO Slurry (Calcium Stearate (FP*) + | 10.2 | 10.2 | 10.2 | 10.2 | 10.2 | 10.2 | 10.2 |
| Irganox B4329) | | | | | | | |
| ZnO | 2 | 2 | 2 | | 2 | | 2 |

FP*: Fused Particles

For comparative purposes, comparative TPVs were formed using polypropylene EPDM mixtures summarized in Table 3. Compositions of comparative examples CEx. 2, CEx. 3, CEx. 4, and CEx. 6 were made according to the formulations shown in Table 2 with the same protocol as described for Ex. 1 except that instead of using ICP, homopolymer polypropylene PP5341 (0.8 MFR, available from ExxonMobil) and an elastomeric (rubber) terpolymer EPDM, Vistalon 1696 (produced by ExxonMobil) were used. Vistalon 1696 EPDM rubber with a Mooney viscosity (ML(1+4) at 125° C.) per ASTM D-1646 of 350 used in the examples of contains 0.7% wt. 5-vinyl-2-norbornene (VNB) as the diene component and 62% ethylene (C2), but did not include any extension oil (oil free).

Compositions of comparative examples CEx. 1, CEx. 4, and CEx. 5 were made according to the formulations shown in Table 3 with the same protocol as described for Ex. 4 except that instead of using CP, homopolymer polypropylene PP5341 (0.8 MFR, available from ExxonMobil Chemical Co.) and an elastomeric (rubber) terpolymer EPDM, Vistalon 1696 (produced by ExxonMobil Chemical Co.) were used. Vistalon 1696 EPDM rubber with a Mooney viscosity (ML(1+4) at 125° C.) per ASTM D-1646 of 350 used in the examples contains 0.7% wt. 5-vinyl-2-norbomnene (VNB) as the diene component and 62% ethylene (C2), but did not include any extension oil (oil free comparative TPV compositions are summarized in Table 3). Compositions of comparative examples CEx. 7, and CEx. 8 were made according to the formulations shown in Table 3 with the same protocol as described for Ex. 4 except that instead of using an ICP including an α,ω-diene, commercially available ICPs were used: PP7143KNE1 is a commercially available ICP of 10 dg/min (230° C., 2.16 kg) MFR, available by the ExxonMobil Chemical Company. PP7033E2 is a commercially available ICP of 8 dg/min (230° C., 2.16 kg) MFR, available by the ExxonMobil Chemical Company.

TABLE 3
Comparative Example TPV Compositions

| Composition | CEx. 1 | CEx. 2 | CEx. 3 | CEx. 4 | CEx. 5 | CEx. 6 | CEx. 7 | CEx. 8 | CEx. 9 |
|---|---|---|---|---|---|---|---|---|---|
| PP7143KNE1 | | | | | | | | 525 | |
| PP7033E2 | | | | | | | 525 | | |
| PP5341 | 525 | 525 | 426 | 426 | 303.6 | 303.6 | | | |
| PP homopolymer | | | | | | | | | 426 |
| (~171 MFR) | | | | | | | | | |
| V1696 (Oil-Free | 100 | 100 | 100 | 100 | 100 | 100 | | | 100 |
| EPDM) | | | | | | | | | |
| Xiameter OFX-5084 | | 4 | 4 | | | 4 | | | 4 |
| PC085 (slurry in oil) | | 5 | 5 | | | 5 | | | 5 |
| AO Slurry (Calcium | 10.2 | 10.2 | 10.2 | 10.2 | 10.2 | 10.2 | 10.2 | | 10.2 |
| Stearate + Irganox | | | | | | | | | |
| B4329) | | | | | | | | | |
| ZnO | | 2 | 2 | | | 2 | | | 2 |

In Table 3, the Homopolymer Polypropylene used as blending component in CEx. 9 was prepared according to the procedure described in “Experimental Detail of Polymerization Reactions” section above using identical polymerization reaction conditions to those corresponding to the homopolymer PP matrix of ICPs A-F of Table 1, except that Stage 2 was not performed (thus no copolymer rubber was made). The MFR of the resultant homopolymer PP used as ingredient in the formulation of CEx. 9 was about 171 g/10 min (230° C., 2.16 kg, ASTM-1238).

Upon completion of Brabender mixing as described above, the molten composition was removed from the mixing bowl, and pressed when hot between Teflon plates into a sheet which was cooled, cut-up, and compression molded at about 400° F. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (about 70° C.). Proper specimens were die cut for the different physical testing (hardness, tensile, tension set, swell in IRM903 and specific gravity.

The physical properties of the TPV compositions and comparative TPV compositions were tested and are summarized in Tables 4 and 5. Shore hardness was measured according to ASTM D2240. Shore A Hardness was measured using a Zwick automated durometer according to ASTM D2240 (15 sec. delay). Shore D Hardness was measured using a Zwick automated durometer according to ASTM D2240. Ultimate tensile strength (“UTS”), modulus at 100% extension (“M100”), and ultimate elongation (“UE”) were measured on compression molded specimens according to ASTM D-412 at 23° C. (unless otherwise specified) at 50 mm per minute by using an Instron testing machine. Tension set was measured according to ASTM D-412 at 70° C. and for 22 h by applying a 10% strain. The tension set measurements were performed 30 min after releasing from tension. The % weight gain (referred to as oil swell) was measured according to ASTM D471 for 24 h and at 121° C. using IRM903 oil. Specific gravity (SG) was measured at 23° C. according to ASTM D792. All other properties were measured as previously stated.

TABLE 4
Physical Properties of Example TPV Compositions

| Composition | Ex. 1 | Ex. 2 | Ex. 3 | Ex. 4 | Ex. 5 | Ex. 6 | Ex. 7 |
|---|---|---|---|---|---|---|---|
| Hardness Shore | 57.7 | 53.7 | 53.1 | 58.6 | 59.6 | 60.2 | 59.1 |
| D (15 sec) | | | | | | | |
| Young's | 1440.4 | 1188.9 | 1141.5 | 1187.8 | 1291.7 | 1216.4 | 1321.8 |
| Modulus (MPa) | | | | | | | |
| Tensile Strength | 22.5 | 19.4 | 18 | 16.9 | 19.8 | 17.4 | 20.9 |
| at Yield (MPa) | | | | | | | |
| Elongation at | 4.6 | 4.9 | 4.4 | 4.5 | 4.5 | 4.2 | 4.8 |
| Yield (%) | | | | | | | |
| Tensile Strength | 18.8 | 17.5 | 17.4 | 16.9 | 17.4 | 16.9 | 16.6 |
| at Break (MPa) | | | | | | | |
| Tension Set | 7.5 | 7.5 | 7 | 9.3 | 9 | 9.5 | 8.3 |
| (% set) | | | | | | | |
| Oil Swell | 6.3 | 10.2 | 12.1 | 12.6 | 8.6 | 12.7 | 7.6 |
| Specific Gravity | 0.9017 | 0.8965 | 0.8980 | 0.8992 | 0.9028 | 0.8991 | 0.9036 |
| Tensile Strength/ | 1.81 | 1.93 | 1.78 | 1.99 | 1.55 | 1.58 | 1.39 |
| % Tension Set | | | | | | | |
| (MPa) | | | | | | | |
| Young's Modulus/ | 94.47 | 150.35 | 95.41 | 173.13 | 129.22 | 101.90 | 70.57 |
| % Oil Swell | | | | | | | |
| (MPa) | | | | | | | |
| (Young's | 5532.31 | 8964.14 | 5745.71 | 10235.41 | 7536.17 | 5875.67 | 3669.42 |
| Modulus * | | | | | | | |
| Hardness)/% Oil | | | | | | | |
| Swell (MPa) | | | | | | | |

TABLE 5
Physical Properties of Comparative Example TPV Compositions

| Composition | CEx. 1 | CEx. 2 | CEx. 3 | CEx. 4 | CEx. 5 | CEx. 6 | CEx. 7 | CEx. 8 | CEx. 9 |
|---|---|---|---|---|---|---|---|---|---|
| Shore | 58.3 | 57.7 | 52 | 52.8 | 54.2 | 53.3 | 56.7 | 55.2 | 51.8 |
| Hardness | | | | | | | | | |
| D (15 sec) | | | | | | | | | |
| Young's | 1115.1 | 1037.2 | 1009.1 | 1031.1 | 861.7 | 795.3 | 1288.9 | 1135.9 | * |
| Modulus | | | | | | | | | |
| (MPa) | | | | | | | | | |
| Tensile | 19.9 | 19.6 | 18 | 18.3 | 15.8 | 15.7 | 20.1 | 15.2 | * |
| Strength at | | | | | | | | | |
| Yield | | | | | | | | | |
| (MPa) | | | | | | | | | |
| Elongation | 11 | 13.9 | 14.4 | 12.7 | 16.2 | 22.7 | 4.8 | 4.5 | * |
| at Yield | | | | | | | | | |
| (%) | | | | | | | | | |
| Tensile | 14 | 13.5 | 12.1 | 13.6 | 11.5 | 22.3 | 14.7 | 14.4 | * |
| Strength at | | | | | | | | | |
| Break | | | | | | | | | |
| (MPa) | | | | | | | | | |
| Tension | 9 | 8.5 | 8.7 | 8.8 | 9.3 | 7.3 | 10 | 9.7 | * |
| Set (% set) | | | | | | | | | |
| Oil Swell | 8.6 | 10.2 | 14.3 | 11.8 | 15.3 | 18.7 | 8 | 20.8 | 14.9 |
| Specific | 0.8978 | 0.9005 | 0.8967 | 0.8916 | 0.8916 | 0.8967 | 0.8974 | 0.8907 | 0.8974 |
| Gravity | | | | | | | | | |
| Tensile | 1.55 | 1.58 | 1.39 | 1.54 | 1.24 | 3.04 | 1.47 | 1.48 | * |
| Strength/ | | | | | | | | | |
| % Tension | | | | | | | | | |
| Set (MPa) | | | | | | | | | |
| Young's | 129.22 | 101.90 | 70.57 | 87.38 | 56.23 | 42.64 | 160.42 | 54.69 | * |
| Modulus/ | | | | | | | | | |
| % Oil | | | | | | | | | |
| Swell | | | | | | | | | |
| (MPa) | | | | | | | | | |
| (Young's | 7536.17 | 5875.67 | 3669.42 | 4613.51 | 3045.48 | 2272.48 | 9092.37 | 3020.09 | * |
| Modulus * | | | | | | | | | |
| Hardness)/ | | | | | | | | | |
| % Oil | | | | | | | | | |
| Swell | | | | | | | | | |
| (MPa) | | | | | | | | | |

* Mechanical properties for CEx. 9 could not be measured as specimens were very brittle and would break upon placed on the instruments.

Much can be inferred from the data presented. For example, at similar hardness (˜58 Shore D), TPV composition Ex. 1 shows significantly higher Young's modulus, tensile strength, lower oil swell weight gain and tension set compared to CEx. 1 and CEx. 2 made with melt blending of PP5341 and V1696 EPDM or compared to ICP CEx. 7. Similarly, at similar hardness (˜53 Shore D), TPV compositions Ex. 2 and Ex. 3 depict significantly higher Young's modulus, tensile strength, lower weight gain and tension set compared to CEx. 5 and CEx. 6 or comparative ICP CEx. 8 (PP17143KNE1 ICP). Additionally, TPV compositions Ex. 5 and Ex. 7 are shown to have significantly better of balance of physical properties compared to CEx. 3 and CEx. 4 based on melt blending of PP5341 and V1696 EPDM or comparative ICP CEx. 7 (PP7033E2 ICP).

In regards to the benefits from crosslinking, Ex. 5 based on ICP F shows that upon crosslinking with Si—H curative, the Young's modulus and tensile strength increase while the oil swell weight gain is significantly reduced relative to Ex. 4 based on ICP F with no curatives. Additionally, Ex. 7 based on ICP E shows that upon crosslinking with Si—H curative, the Young's modulus and tensile strength increase while the oil swell weight gain is significantly reduced relative to Ex. 6 based on ICP E with no curatives.

Overall, it has been discovered that the addition of α,ω-dienes to the elastomeric component (Compound B) of an ICP and subsequent crosslinking can provide a TPV with an improved balance of physical properties. For example, TPVs may have step out improvements in hardness, tensile strength, elastic recovery, and oil swell without sacrificing other physical properties. Additionally, the ICP may be made as a reactor blend which is then crosslinked to form a TPV, taking fewer steps and consuming less energy and time than previous processes. For example, the use of reactor blend ICP to form the TPV reduces or eliminates the need to granulate rubber bales into the extruder.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise whenever a composition, an element or a group of elements is preceded with the transitional phrase “including,” it is understood that we also contemplate the same composition or group of elements with transitional phrases “consisting essentially of,” “consisting of,” “selected from the group of consisting of,” or “is” preceding the recitation of the composition, element, or elements and vice versa. The compositions, processes, or articles disclosed may be practiced in the absence of any element which is not disclosed herein.

While the present disclosure has been described with respect to a number of embodiments and examples, those skilled in the art, having benefit of this disclosure, will appreciate that other embodiments can be devised which do not depart from the scope and spirit of the present disclosure.

1-47. (canceled)

48. A thermoplastic vulcanizate comprising:
a polypropylene; and
a copolymer comprising an ethylene content, a propylene content, and an α,ω-diene content, wherein the copolymer is crosslinked;
the thermoplastic vulcanizate having a shore hardness of about 20 Shore A or greater.

49. The thermoplastic vulcanizate of claim 48, further comprising one or more fillers selected from the group consisting of: calcium carbonate, clay, silica, talc, titanium dioxide, carbon black, organic and inorganic nanoscopic fillers, and combination(s) thereof.

50. The thermoplastic vulcanizate of claim 48, further comprising a plasticizer or oil comprising a mineral oil, a synthetic oil, an ester plasticizer or a combination thereof.

51. The thermoplastic vulcanizate of claim 50, wherein the mineral oil comprises an aromatic oil, a naphthenic oil, a paraffinic oil, an isoparaffinic oil, a synthetic oil, or any combination thereof.

52. The thermoplastic vulcanizate of claim 48, further comprising a curing system.

53. The thermoplastic vulcanizate of claim 52, wherein the curing system comprises hydrosilylation curatives.

54. The thermoplastic vulcanizate of claim 52, wherein the curing system comprises a phenolic resin and a cure accelerator.

55. The thermoplastic vulcanizate of claim 54, wherein the cure accelerator is stannous chloride.

56. The thermoplastic vulcanizate of claim 52, wherein the curing system comprises peroxide.

57. The thermoplastic vulcanizate of claim 52, wherein the curing system is a silane grafting and moisture curing system.

58. The thermoplastic vulcanizate of claim 48, wherein the thermoplastic vulcanizate has a Young's modulus of about 1100 MPa or greater.

59. The thermoplastic vulcanizate of claim 48, wherein the thermoplastic vulcanizate has a tensile strength at yield of about 18 MPa or greater.

60. The thermoplastic vulcanizate of claim 48, wherein the thermoplastic vulcanizate has an elongation at yield of about 6% or less.

61. The thermoplastic vulcanizate of claim 48, wherein the thermoplastic vulcanizate has a tensile strength at break of about 17 MPa or greater.

62. The thermoplastic vulcanizate of claim 48, wherein the thermoplastic vulcanizate has a tension set of about 9% or less.

63. The thermoplastic vulcanizate of claim 48, wherein the thermoplastic vulcanizate has an oil swell of about 15% weight gain or less.

64. The thermoplastic vulcanizate of claim 48, wherein the thermoplastic vulcanizate copolymer has an α,ω-diene content of about 1 wt % to about 10 wt %.

65. The thermoplastic vulcanizate of claim 48, wherein the thermoplastic vulcanizate further comprises particles of the copolymer dispersed in the polypropylene and about 75% of the particles have an average diameter of about 5 pm or less.

66. The thermoplastic vulcanizate of claim 48, wherein the thermoplastic vulcanizate has a melt flow rate of about 5 g/10 min to about 200 g/10 min.

67. An article of manufacture comprising the thermoplastic vulcanizate of claim 48.

68. The article of manufacture of claim 67, wherein the article of manufacture is selected from the group consisting of glass ran channel weatherseals, corner moldings, seals, gaskets, flexible pipe for petroleum application, and thermoplastic composite pipe.

69. A process for producing a thermoplastic vulcanizate, the process comprising:
introducing a catalyst and propylene to a first reactor to form a first polymer;
introducing the first polymer, ethylene, at least one α,ω-diene, and additional propylene to a second reactor to form an impact copolymer; and
crosslinking the impact copolymer.

70. The process of claim 69, wherein the α,ω-diene is selected from the group consisting of 1,5-hexadiene, 1,6-heptadiene, 1,7-octadiene, 1,8-nondiene, 1,9-decadiene, 1,10-undecadiene, 1,11-dodecadiene, 1,12-tridecadiene, 1,13-tetradecadiene, 1,14-pentadecadiene, 1,15-hexadecadiene, and combination(s) thereof.

71. The process of claim 69, further comprising introducing hydrogen to the first reactor.

72. The process of claim 69, further comprising removing hydrogen before introducing the first polymer to the second reactor.

73. The process of claim 69, wherein the first polymer has a vinyl content of about 0.05 or greater.

74. The process of claim 69, wherein the crosslinking further comprises introducing a curing agent to form a curing composition.

75. The process of claim 74, wherein the crosslinking further comprises exposing the curing composition to a temperature of about 160° C. or greater.

76. The process of claim 74, wherein the crosslinking further comprises exposing the curing composition to vulcanization concurrently with mixing or extruding.

77. The process of claim 69, wherein the first polymer has a density of from about 0.90 g/cm³ to about 0.91 g/cm³ and an melt flow rate of from about 0.1 g/10 min to about 600 g/10 min.
